(19) United States
(12) Patent Application Publication
(10) Pub. No.: US 2026/0081840 A1
(43) Pub. Date: Mar. 19, 2026

(54) SYSTEMS AND METHODS FOR MAPPING, MIGRATING, AND/OR PROCESSING DATA OVER A NETWORK

(71) Applicant: University of Washington, Seattle, WA (US)

(72) Inventors: Mohammed A. Jasim, Seattle, WA (US); Nazli Siasi, Seattle, WA (US)

(21) Appl. No.: 19/134,173

(22) PCT Filed: Jan. 10, 2024
(86) PCT No.: PCT/US2024/011087

§ 371 Date: May 29, 2025

Related U.S. Application Data
(60) Provisional application No. 63/438,735, filed on Jan. 12, 2023.

(51) Int. Cl. H04L 41/0897; H04L 41/0895; H04L 41/40; H04L 43/16; H04L 47/50

(52) U.S. Cl. CPC H04L 41/0897; H04L 41/0895; H04L 41/40; H04L 43/16; H04L 47/50

(57) ABSTRACT

This disclosure describes systems and methods for mapping, migrating, and/or processing data over a network. The network utilizes a heterogeneous fog architecture having hyper fog nodes and regular fog nodes. The hyper fog node may determine a time-delay requirement and a computation requirement of an application of a terminal device. The hyper fog node groups or clusters virtual network functions (VNFs) in a service function chain (SFC) associated with the application. The hyper fog node monitors a data traffic threshold associated with the plurality of VNFs. If the data traffic threshold is met, the hyper fog node may migrate the VNFs to one or more regular fog nodes.

### CROSS-REFERENCE TO RELATED APPLICATIONS

This application claims the benefit under 35 U.S.C. § 119(e) of the earlier filing date of U.S. Provisional Application No. 63/438,735, filed Jan. 12, 2023, the entire contents of which are hereby incorporated by reference in their entirety for any purpose.

### BACKGROUND

Some network systems may use fog computing by using intermediate computing processing between terminals and a cloud core (or cloud node(s)). These network systems may arrange the terminals in a first layer or a terminals layer, fog nodes in a second layer(s) or a fog layer, and the cloud core or the cloud nodes in a third layer or a cloud layer. The terminals may run applications by migrating data traffic to, and/or from, the fog nodes and/or the cloud core. The computing systems at the fog nodes and/or the cloud core may perform computations on the data and provide results back to the user and/or other fog or cloud nodes.

The fog nodes may be arranged in a variety of fog architectures, such as in multi-tier fog architectures, hybrid fog cloud architectures, distributed fog architectures, or overlaid fog architectures.

When executing applications, some fog architectures can employ service function chain (SFC) provisioning schemes to map delay-sensitive requests on fog nodes and computation-intensive requests on cloud nodes. Generally, an SFC includes a plurality of virtual network functions (VNFs) associated with an application or a service request. The techniques used in SFC provisioning schemes may include placing the plurality of VNFs across a plurality of fog nodes (e.g., physical fog nodes).

Some network systems may use fog architectures that may include service nodes for hosting functions; registration nodes for authentication; and/or management nodes for maintaining load balancing between the other fog nodes (e.g., service nodes). The management nodes, however, often impose additional latency and traffic control signaling that adds a time-delay overhead, thereby degrading the quality of service (QoS), and/or reducing the data traffic capacity in the network systems.

Some network systems may use multi-tier fog architectures by assigning different functions to different tiers of varying type, size, and/or latency based on the application. As such, each tier of the multi-tier fog architecture differs from the other tiers. For example, the fog nodes in the lower tiers of the multi-tier fog architecture may require and/or utilize less processing, communication, and/or storage capacities compared to the fog nodes in the high tiers of the multi-tier fog architectures.

Some network systems with multi-layer fog architectures may utilize delay-aware provisioning solutions, where the delay-aware provisioning solutions may include greedy heuristics provisioning objectives.

Some network systems may use overlaid fog architectures, where the overlaid fog architectures may support the execution of applications of the terminals using local computing resources of the terminals. Some fog nodes in the overlaid fog architectures may create an application management layer to provide service composition on the terminals. The overlaid fog architecture may support lower tiers with an increased management, function migration, resources, and/or backup computation and/or storage resources. Unfortunately, the overlaid fog architectures may also add latencies when migrating data traffic and/or computation requests from the lower tiers to the upper tiers, which, for example, may reduce the QoS of the delay-sensitive applications.

Some network systems may use a platform as-a-service (PaaS) architecture for applications in hybrid fog cloud architectures. These network systems often consider only a single VNF type, and these network systems may not perform VNF placements in the fog layer or the fog nodes.

Some network systems may utilize control, signaling, and data interface mechanisms in, for example, healthcare applications across fog and cloud layers, without utilizing VNF mapping.

Some network systems utilize a Tabu-based search for SFC provisioning in fog architectures to achieve increased time-delay and load efficiencies, where the Tabu-based search is a metaheuristic search method.

Some network systems may utilize an SFC controller to facilitate bidirectional communications between fog and cloud nodes. These network systems may adopt a container-based approach for smart city use cases (e.g., surveillance, waste management) in efforts to maintain bandwidth conservation and latency reduction. Unfortunately, these SFC controllers may suffer from high execution time delays, low data traffic volumes, and/or network saturations. Also, the SFC controller may add redundant data traffic and may lower the utilization of the resources of the network system.

### BRIEF SUMMARY

Example data networks are disclosed herein. In an embodiment, an example data network includes an alpha node, a first beta node, and a second beta node, where each of the first and the second beta nodes are communicatively coupled to the alpha node. The alpha node may be configurable to receive data traffic belonging to one or more requests from one or more user devices and check or monitor whether a threshold of data traffic is met. Upon meeting the threshold, the alpha node may generate a queue to the first beta node, the second beta node, or a combination thereof. The alpha node may assign one or more factors from a plurality of factors to at least a portion of the data traffic, where each of the plurality of factors comprises a type of the data traffic, a total amount of the portion of the data traffic, a first amount of the portion of the data traffic accepted by the first beta node, a second amount of the portion of the data traffic accepted by the second beta node, or combinations thereof. Based, in part, on the one or more factors, the alpha node may selectively migrate the first and the second amounts of the portion of the data traffic to the first and the second beta nodes, respectively, by using a migration scheme of a plurality of migration schemes.

Additionally, or alternatively, the first and the second beta nodes are further communicatively coupled to each other.

Additionally, or alternatively, the alpha node, the first beta node, and the second beta node are neighboring nodes.

Additionally, or alternatively, the migration scheme may include a high or highest resources first (HRF) migration scheme.

Additionally, or alternatively, the migration scheme may include a low or lowest resources first (LRF) migration scheme.

Additionally, or alternatively, the migration scheme may include a high or highest virtual network functions (VNFs) first migration scheme.

Additionally, or alternatively, the migration scheme may include a low or lowest count of VNFs first migration scheme.

Additionally, or alternatively, the alpha node may include a baseband unit (BBU) collocated with an alpha radio remote head (RRH).

Additionally, or alternatively, one of the first and the second beta nodes may include a server collocated with a beta RRH.

Additionally, or alternatively, the alpha RRH may include a first power RRH, the beta RRH may include a second power RRH, and where the first power RRH may include a higher power than the second power RRH.

Additionally, or alternatively, the alpha node may include a first computational and memory capacity, each of the first and the second beta nodes may include a second computational and memory capacity, and where the first computational and memory capacity may include a higher capacity than the second computational and memory capacity.

Additionally, or alternatively, the type of the data traffic may include a time-delay threshold for processing the one or more data requests.

Additionally, or alternatively, the total amount of the one or more portions of the data traffic may include a computation-intensive characteristic, and where the computation-intensive characteristic may include one or more of a measures of: a processing speed, a processing power, an amount of memory, a data traffic intensity, or combinations thereof.

Additionally, or alternatively, the example data network may further include a heterogeneous fog architecture with one or more tree structures, where the alpha node may include a root node of each of the one or more tree structures, the first beta node may include a first leaf node of each of the one or more tree structures, and the second beta node may include a second leaf node of each of the one or more tree structures.

Example methods for performing computations over a network are disclosed herein. In an embodiment of the disclosure, an example method of performing computations over a network includes determining, using a hyper fog node, a time-delay requirement and a computation requirement of an application of a terminal device. The method may include grouping, using the hyper fog node, a plurality of virtual network functions (VNFs) in a service function chain (SFC) associated with the application. The method may include, for example, using the hyper fog node, monitoring a data traffic threshold associated with the plurality of VNFs. Upon meeting the data traffic threshold, the method may include migrating the plurality of VNFs from the hyper fog node to one or more regular fog nodes.

Additionally, or alternatively, the method may further include maintaining the hyper fog node in an active operation mode.

Additionally, or alternatively, the method may further include maintaining the one or more regular fog nodes in an idle operation mode prior to the migrating, where the idle operation mode decreases an amount of energy used by the one or more regular fog nodes.

Additionally, or alternatively, the method may further include determining a type of each VNF of the plurality of VNFs. Based on the type of each VNF of the plurality of VNFs, the method may include, for example, using the hyper fog node, selecting a migration scheme of a plurality of migration schemes.

Additionally, or alternatively, the migrating uses a high or highest resources first (HRF) migration scheme.

Additionally, or alternatively, the migrating uses a low or lowest resources first (LRF) migration scheme.

Additionally, or alternatively, the migrating uses a high or highest VNFs first migration scheme.

Additionally, or alternatively, the migrating uses a low or lowest VNFs first migration scheme.

### BRIEF DESCRIPTION OF THE DRAWINGS

FIG. 1 illustrates a diagram of a network system having a cloud layer, a fog layer, and a terminal device(s) layer, in accordance with examples described herein.

FIG. 2 illustrates another diagram of a network system having a fog layer and a terminal device layer, in accordance with examples described herein.

FIG. 3 illustrates a diagram of a heterogeneous fog architecture with hyper fog nodes, regular fog nodes, and terminal devices, in accordance with examples described herein.

FIG. 4 illustrates a diagram of a quadratic tree of the heterogeneous fog architecture of FIG. 3, in accordance with examples described herein.

FIGS. 5A and 5B, collectively, show an example pseudocode of an SFC provisioning scheme utilized by a hyper fog node, in accordance with examples described herein.

FIG. 6 illustrates a diagram of a heterogeneous fog architecture that includes a hyper fog node having a relatively low utilization rate, in accordance with examples described herein.

FIG. 7 illustrates another diagram of a heterogeneous fog architecture that includes a hyper fog node having a considerably high, or a saturated, utilization rate, in accordance with examples described herein.

FIG. 8 illustrates another diagram of a heterogeneous fog architecture that includes a hyper fog node that utilizes a highest resource first migration scheme to migrate data from the hyper fog node to regular fog nodes of the heterogeneous fog architecture, in accordance with examples described herein.

FIG. 9 illustrates another diagram of a heterogeneous fog architecture that includes a hyper fog node that utilizes a lowest resources first migration scheme to migrate data from the hyper fog node to regular fog nodes of the heterogeneous fog architecture, in accordance with examples described herein.

FIG. 10 illustrates another diagram of a heterogeneous fog architecture that includes a hyper fog node that utilizes a highest VNF first migration scheme to migrate data from the hyper fog node to regular fog nodes of the heterogeneous fog architecture, in accordance with examples described herein.

FIG. 11 illustrates another diagram of a heterogeneous fog architecture that includes a hyper fog node that utilizes a lowest VNF first migration scheme to migrate data from the hyper fog node to regular fog nodes of the heterogeneous fog architecture, in accordance with examples described herein.

FIGS. 12A and 12B, collectively, show an example pseudocode for migrating data traffic from a hyper fog node to one or more regular fog nodes, in accordance with examples described herein.

FIGS. 13A to 13E, collectively, show Equations 1 to 34 used in the systems and methods for mapping, migrating, and/or processing data over the network system, in accordance with examples described herein.

FIGS. 14A to 14I illustrate example results of the performance of systems and methods for mapping, migrating, and/or processing data over the network system.

### DETAILED DESCRIPTION

SFC provisioning schemes often map delay-sensitive requests on a fog layer, and often map computation-intensive requests on a cloud layer. Requests, however, can sometimes include both delay-sensitive requests (or stringent delays) and computation-intensive requests. For a delay-sensitive request, mapping the associated VNFs on the cloud layer may incur prolonged delays that exceed the latency bound for users or the applications of the terminal devices. Servicing these delay-sensitive requests on the cloud layer may degrade the QoS for the user or the applications and may reduce the traffic capacity over the network.

Examples described herein include requests that may be associated with applications of terminal devices. The requests may be delay-sensitive and computation-intensive at the same time in some examples. In some embodiments, the fog layer may utilize a heterogeneous fog architecture. The heterogeneous fog architecture can process (or compute) and/or store requests, where the requests may be delay-sensitive requests and computation-intensive, often, without relying on the cloud layer. In some embodiments, the heterogeneous fog architecture may reduce processing delays over a network system; reduce propagation delays over the network system; lower power consumption of the network system and/or the heterogeneous fog layer architecture; increase traffic capacity over the network system and/or the heterogeneous fog layer architecture; or a combination thereof.

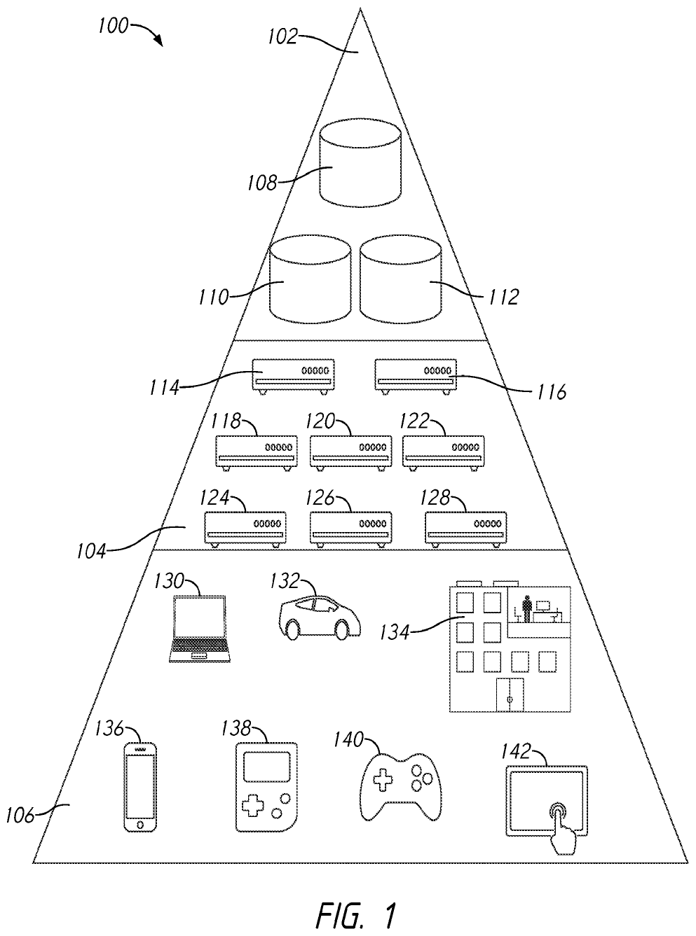

FIG. 1 illustrates a network system 100 with a cloud layer 102, a fog layer 104, and a terminal device layer 106, in accordance with examples described herein. The network system 100 and any other network system described herein may be a data network used to communicate, process, store, communicate, migrate, and so forth one or more types of data and/or one or more types of data traffic.

In some embodiments, the cloud layer 102 may include a cloud node 108, a cloud node 110, a cloud node 112, and additional cloud nodes, or fewer cloud nodes, than what is illustrated in FIG. 1. Nodes described herein generally include one or more processor(s). A node may be implemented, for example, using one or more servers and/or other computing systems.

In some embodiments, the fog layer 104 may include a fog node 114, a fog node 116, a fog node 118, a fog node 120, a fog node 122, a fog node 124, a fog node 126, a fog node 128, additional fog nodes, or fewer fog nodes, than what is illustrated in FIG. 1.

In some embodiments, the terminal device layer 106 may include a terminal device 130, a terminal device 132, a terminal device 134, a terminal device 136, a terminal device 138, a terminal device 140, a terminal device 142, additional terminal devices, or fewer terminal devices, than what is illustrated in FIG. 1. FIG. 1 illustrates the terminal devices as being a laptop computer; an autonomous vehicle, a driverless vehicle, and/or a vehicle having driver assistance; a smart home and/or a home with internet of things (IoT) devices; a smartphone; a handheld game console: a stationary or home game console; and a tablet. Nevertheless, the terminal device layer 106 may include other types of terminal devices, user devices, edge devices, and the like. One, some, or all of the terminal devices of the terminal device layer 106 can generate one or more data requests, and the terminal device(s) can request data and/or computation from the fog layer 104 and/or the cloud layer 102. In some embodiments, the fog layer 104 and/or the cloud layer 102 may temporarily or permanently store data sent from the terminal devices. It is to be understood that the user has control over which data is sent to the fog layer 104 and/or the cloud layer 102.

In some embodiments, the count of terminal devices in the terminal device layer 106 is greater than the count of fog nodes in the fog layer 104, and the count of fog nodes in the fog layer 104 is greater than the count of cloud nodes in the cloud layer 102.

In some embodiments, a difference between computing using the cloud layer 102 and using the fog layer 104 is the location of their respective nodes compared to the terminal devices 130 to 142. Generally, a first average distance between one, some, or all of the fog nodes 114 to 128 and one, some, or all of the terminal devices 130 to 142 is smaller than a second distance between one, some, or all of the cloud nodes 108 to 112 and one, some, or all of the terminal devices 130 to 142. Latency may in some examples generally vary in accordance with distance. Nodes being a further distance away may have a greater latency in servicing requests than nodes closer to the terminal device(s).

In some embodiments, a difference between the cloud nodes 108 to 112 of the cloud layer 102 and the fog nodes 114 to 128 of the fog layer 104 is the amount or capacity of processing and/or memory resources, where the cloud nodes 108 to 112 may include considerably more resources compared to the fog nodes 114 to 128. For example, each of the cloud nodes 108 to 112 may have a greater computational and/or memory capacity than one, some, or all of the fog nodes 114 to 128.

Generally, cloud computing suffers from higher latency compared to fog computing because data traffic associated with requests from the terminal devices needs to travel a considerably larger distance. Therefore, a more efficient fog architecture can increase the QoS.

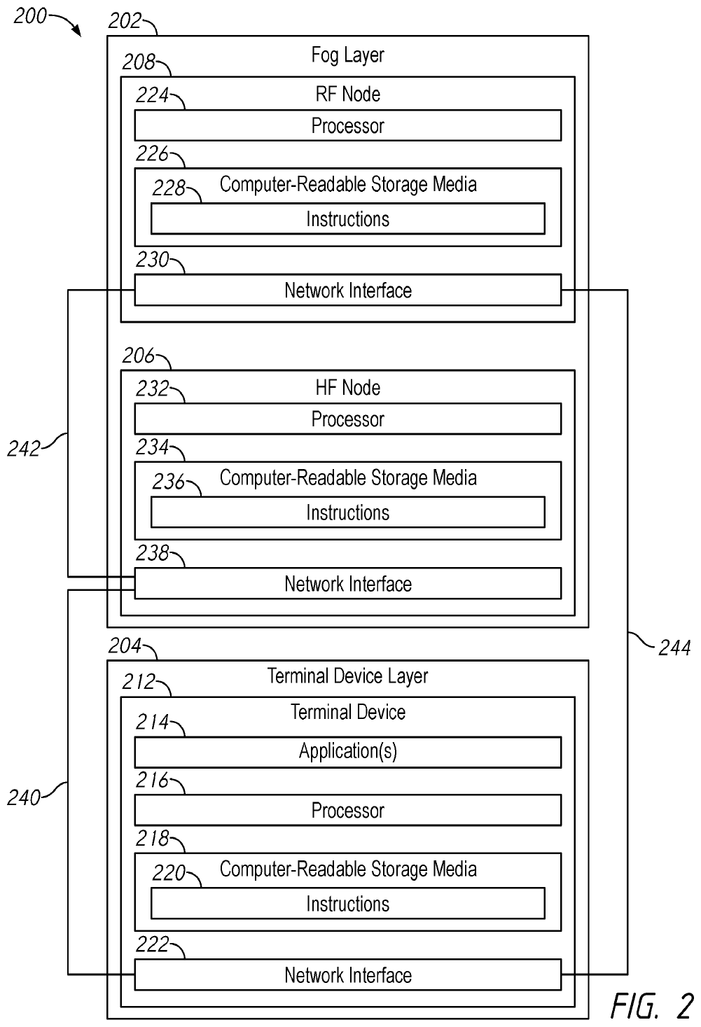

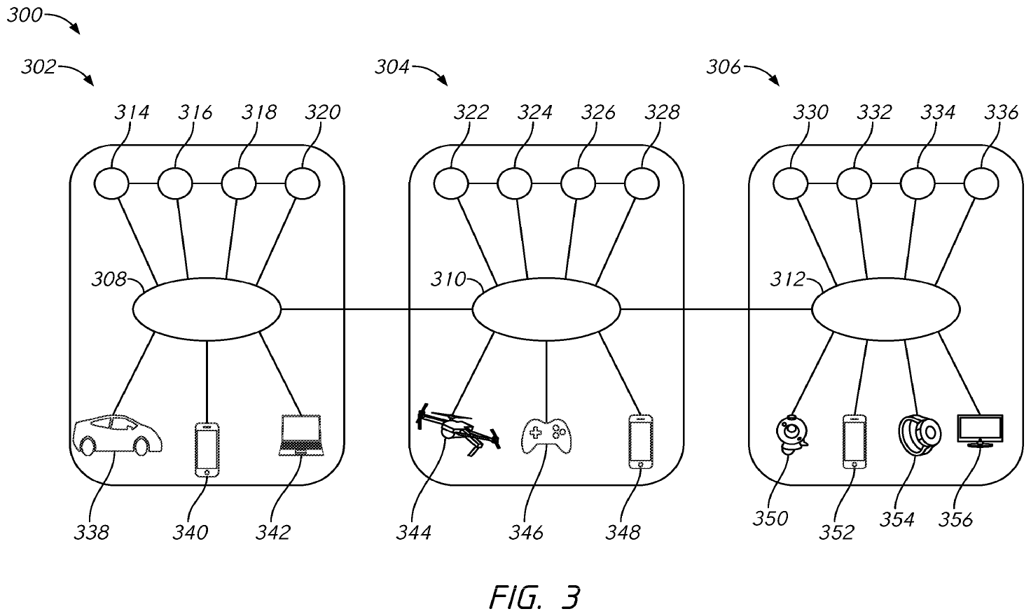

FIG. 2 illustrates a diagram of a network system 200 having a fog layer 202 and a terminal device layer 204, in accordance with examples described herein. For the sake of brevity, the network system 200 does not illustrate and/or describe a cloud layer. The network system 200 of FIG. 2 may be an example implementation of the network system 100 of FIG. 1 or a portion of the network system 100 of FIG. 1. The fog layer 202 may be an example implementation of the fog layer 104 of FIG. 1 or a portion of the fog layer 104 of FIG. 1. The terminal device layer 204 of FIG. 2 may be an example implementation of the terminal device layer 106 of FIG. 1 or a portion of the terminal device layer 106 of FIG. 1.

In some embodiments, the fog layer 202 may include a hyper fog (HF) node 206 and a regular fog (RF) node 208. In some embodiments, the fog layer may include additional HF nodes and additional RF nodes. In some embodiments, the count of RF nodes in a fog layer may be greater than the count of HF nodes in the fog layer. In this disclosure, the terms HF node, alpha node, parent, and root node may be used interchangeably. In this disclosure, the terms RF node, beta node, child(ren), and leaf node may be used interchangeably.

In some embodiments, the terminal device layer 204 may include a terminal device 212 and additional terminal devices that are not explicitly illustrated in FIG. 2.

In some embodiments, the terminal device 212 may include an application(s) 214, a processor 216, a computer-readable storage media 218 (or a computer-readable medium), instructions 220, a network interface 222, and additional components that are not explicitly illustrated in FIG. 2. The terminal device 212 may utilize processor 216 to execute instructions 220 to perform functions described herein as occurring on or by the terminal device 212.

In some embodiments, the RF node 208 may include a processor 224, a computer-readable storage media 226 (or a computer-readable medium), instructions 228, a network interface 230, and additional components that are not explicitly illustrated in FIG. 2. The RF node 208 may utilize the processor 224 to execute the instructions 228 to perform functions described herein as occurring on or by the RF node 208.

In some embodiments, the HF node 206 may include a processor 232, a computer-readable storage medium 234 (or a computer-readable medium), instructions 236, a network interface 238, and additional components that are not explicitly illustrated in FIG. 2. The HF node 206 may utilize the processor 232 to execute the instructions 236 to perform functions described herein as occurring on or by the HF node 206.

In some embodiments, the terminal device 212 may communicate with the HF node 206 using a communication coupling 240. In some embodiments, the HF node 206 may communicate with the RF node 208 using a communication coupling 242. In some embodiments, the RF node 208 may communicate with the terminal device 212 using a communication coupling 244.

In some embodiments, the communication couplings 240, 242, and 244 may be, include, and/or operate in accordance with one or more communication protocols and/or standards. Examples of such protocols and standards include: a 3rd Generation Partnership Project (3GPP) Long-Term Evolution (LTE) standard, such as a 4th Generation (4G) or a 5th Generation (5G) cellular standard: an Institute of Electrical and Electronics (IEEE) 802.11 standard, such as IEEE 802.11g, ac, ax, ad, aj, or ay (e.g., Wi-Fi 6® or WiGig®): an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and/or standards that may be established and/or maintained by various governmental, industry, and/or academia consortiums, organizations, and/or agencies; and so forth. Therefore, the network system 200 of FIG. 2 and/or network system 100 of FIG. 1 may include a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, a Global Navigation Satellite System (GNSS) (e.g., Global Positioning System (GPS)), etc. Additionally, or alternatively, the communications (not explicitly illustrated in FIG. 2) of the network system 200 of FIG. 2 and/or the network system 100 of FIG. 1 may facilitate unidirectional, bidirectional, wired, wireless, direct, and/or indirect communications utilizing one or more communication protocols and/or standards.

In some embodiments, the application(s) 214 may be implemented using software, an applet, a peripheral, or other entity that can be used during, or in association with, the terminal device 212. In some examples, the application(s) 214 may be implemented wholly or partially using executable instructions 220 stored in computer-readable storage media 218 of the terminal device 212, the instructions 236 stored in computer-readable storage media 234 of the HF node 206, and/or the instructions 228 of the computer-readable storage media 226 of the RF node 208. In some embodiments, when the terminal device 212 uses the fog layer 202 to execute the application(s) 214, the terminal device 212 sends requests associated with the application(s) 214 to the fog layer 202.

In some embodiments, each, or any of the processor 216, the processor 224, and the processor 232 may be or may include any electronic device that may be capable of processing, receiving, and/or transmitting the instructions that may be included in, permanently or temporarily saved on, and/or accessed by the memory or computer-readable media. In aspects, the computational resources or the processors 216, 224, and 232 may be implemented using one or more processors (e.g., a central processing unit (CPU), a graphic processing unit (GPU)), and/or other circuitry, where the other circuitry may include at least one or more of an application specific integrated circuit (ASIC), a field programmable gate array (FPGA), a microprocessor, a microcomputer, and/or the like.

In some embodiments, the memory resources, or the computer-readable storage media 218, the computer-readable storage media 226, and/or the computer-readable storage media 234 included in, and/or utilized by, the terminal devices, the HF nodes, and/or the RF nodes may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth.

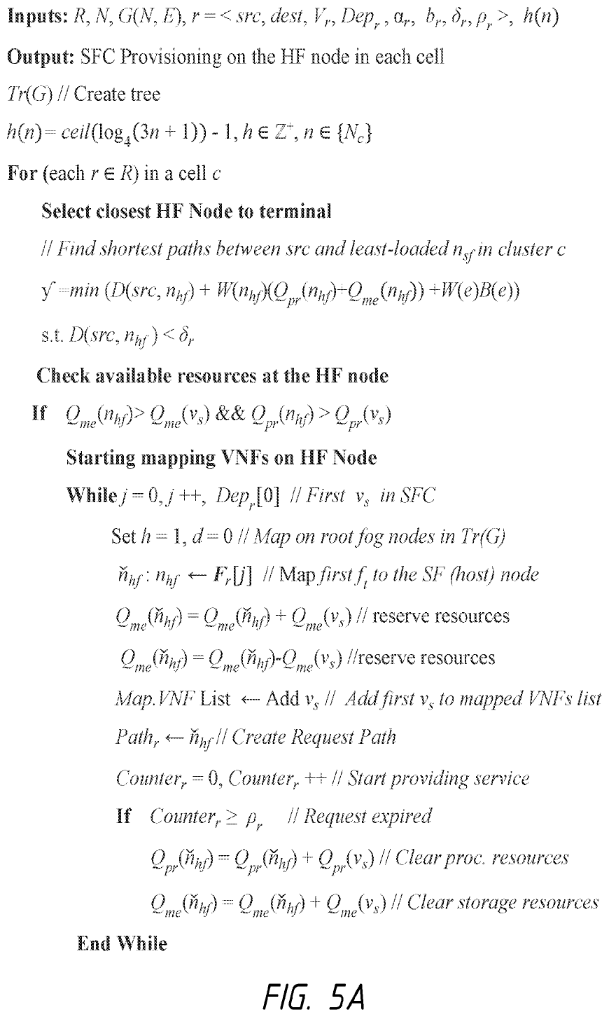

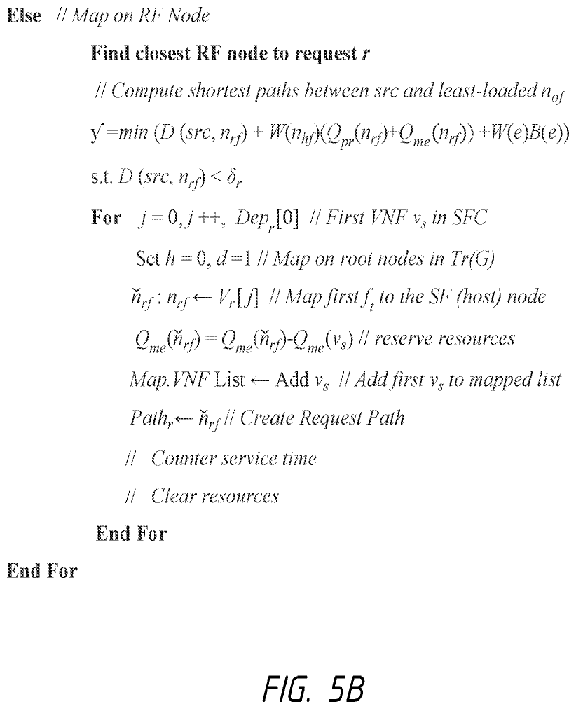

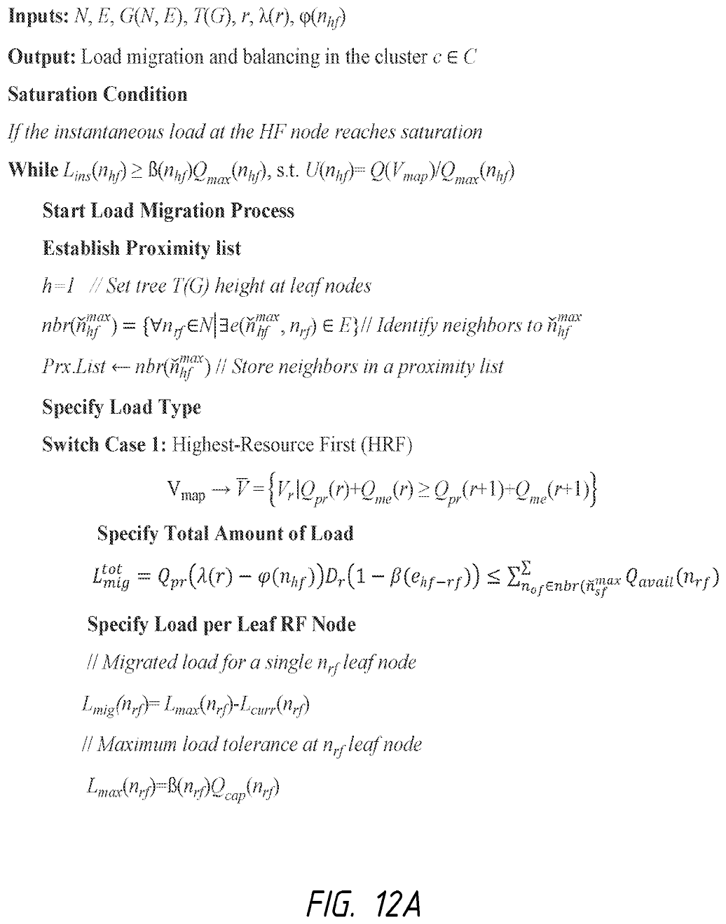

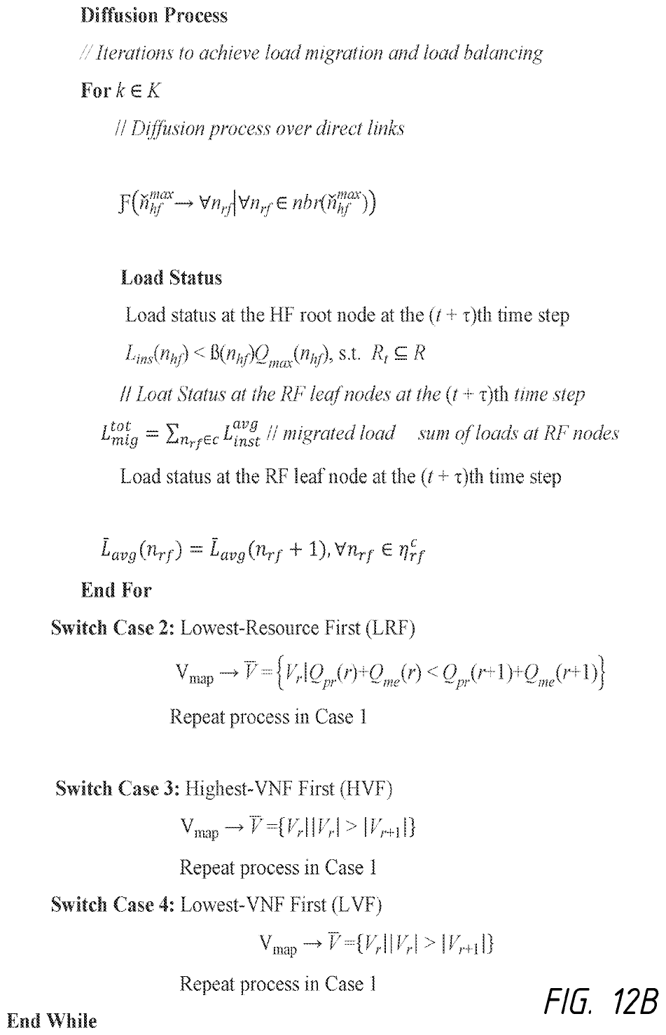

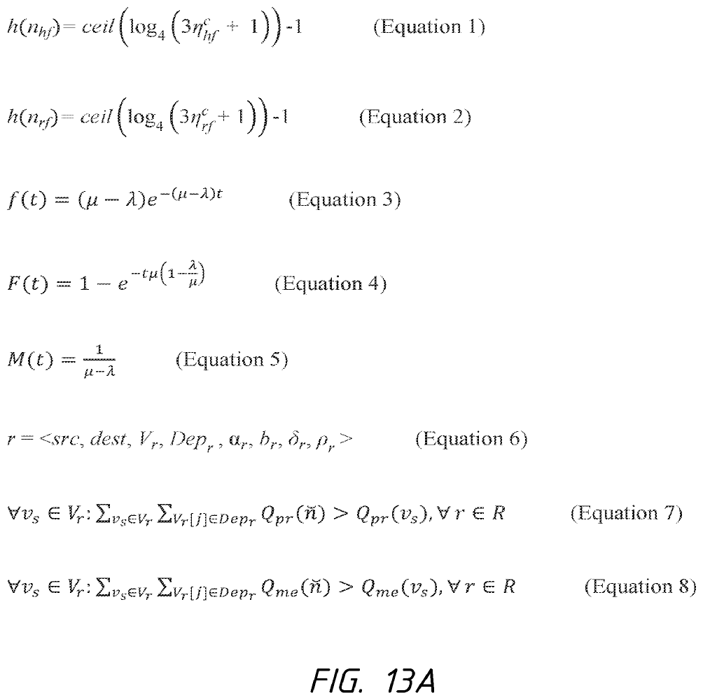

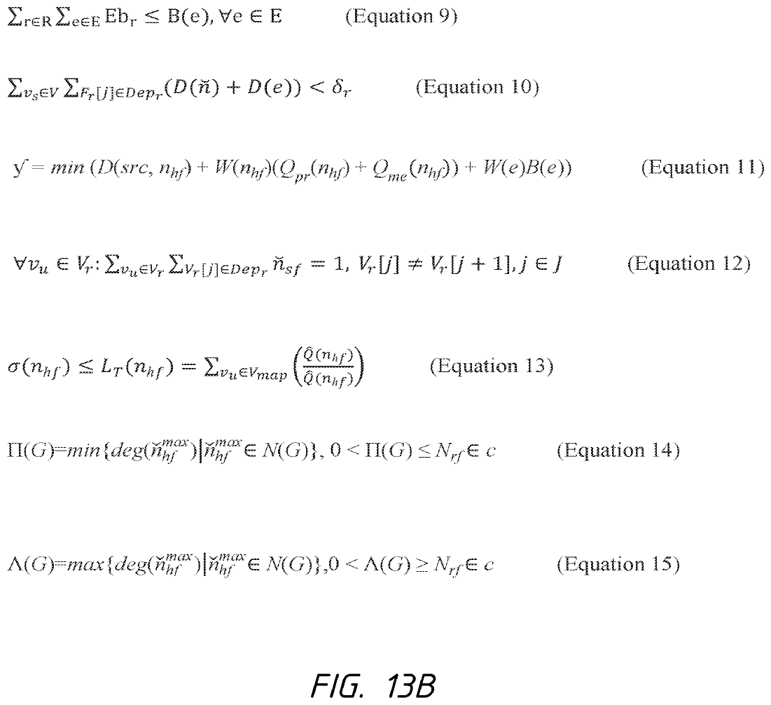

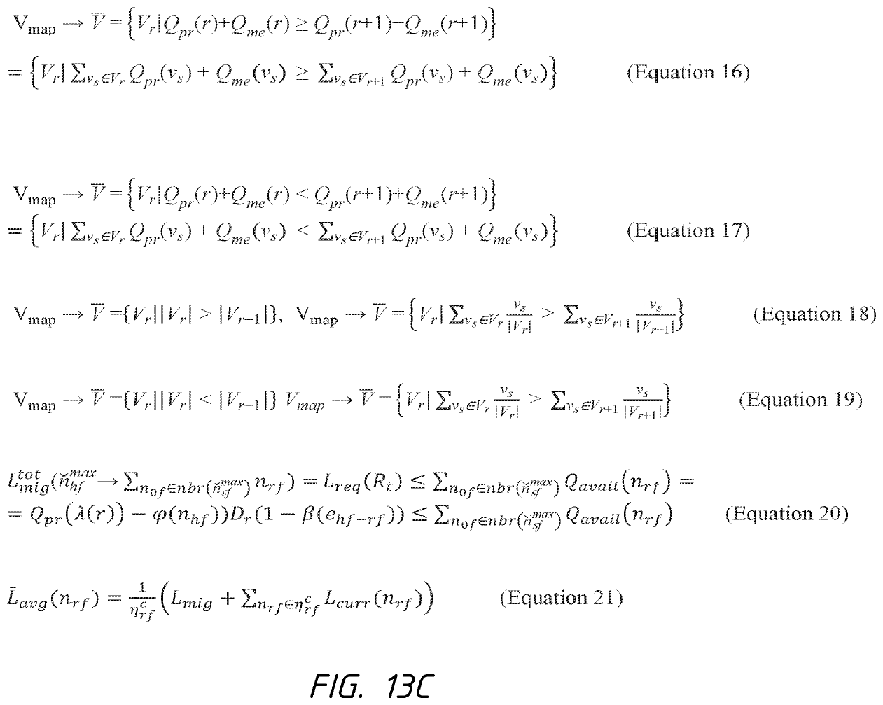

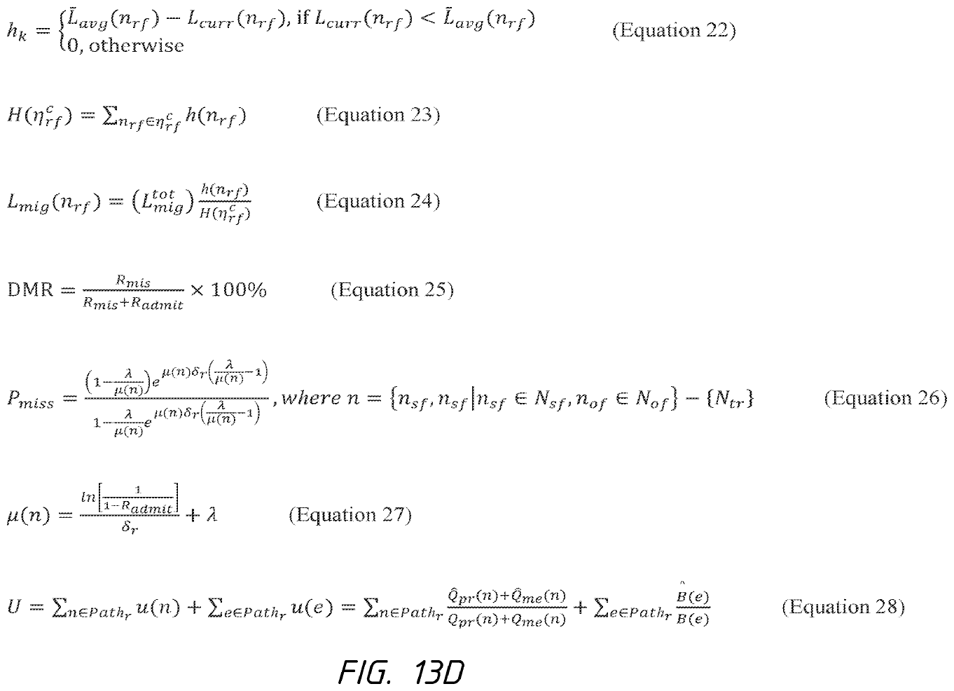

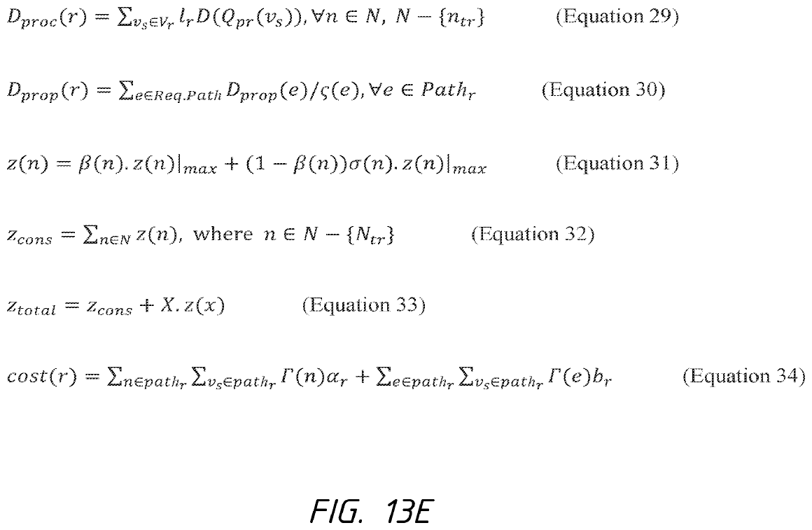

In some embodiments, the instructions 220, the instructions 228, and the instructions 236 may be included in, permanently or temporarily saved on, and/or accessed by the computer-readable storage media 218, the computer-readable storage media 226, and computer-readable storage media 234, respectively. The instructions may include code, pseudocode, algorithms, models (e.g., machine-learning models), software modules, and/or mathematical formulas, and so forth, and the instructions are executable by the computational resources or the processor(s). The instructions 220, the instructions 228, and the instructions 236 differ from each other. Examples of pseudocode may include the pseudocodes shown in FIGS. 5A, 5B, 12A, and 12B. Examples of formulas may include the formulas shown in FIGS. 13A, 13B, 13C, 13D, and 13E.

In some embodiments, the terminal device 212, the HF node 206, and the RF node 208 may utilize their respective network interfaces (e.g., the network interface 222, the network interface 238, and network interface 230) to communicate with each other directly or indirectly. Each or any of the network interfaces 222, 230, and 238 illustrated in FIG. 2 may include and/or utilize an application programming interface (API) that may interface, migrate, and/or translate requests to and/or from the terminal device 212 and the HF node 206, the HF node 206 and the RF node 208, the RF node 208 and the terminal device 212, and so forth. It is to be understood that the network interfaces 222, 230, and 238 may support a wired and/or a wireless communication using any of the described communication protocols and/or standards.

In some embodiments, the application(s) 214 initiated from the terminal device 212 can include delay-sensitive requests, computation-intensive requests, or a combination thereof. A delay-sensitive request may be a request that needs to be processed under a threshold time delay (e.g., under 5, 10, etc., milliseconds (ms)). A computation-intensive request may be a request that demands a threshold minimum of computational resources. In some embodiments, even when an application includes delay-sensitive requests and computation-intensive requests at the same time, the fog layer 202 can handle these requests. In some embodiments, the fog layer 202 may reduce processing delays over a network system (e.g., the network system 100 of FIG. 1, the network system 200 of FIG. 2) and/or the fog layer 202; reduce propagation delays over the network system and/or the fog layer 202: lower power consumption of the network system and/or the fog layer 202; increase traffic capacity over the network system and/or the fog layer 202; or a combination thereof compared to a conventional (e.g., prior art) fog architecture.

In some embodiments, the terminal device 212, for example, using the application(s) 214, may generate requests or data traffic; and the one or more of the terminal device 212 may demand services from the network system 200 of FIG. 2, the network system 100 of FIG. 1, the fog layer 202 of FIG. 2, and/or fog layer 104 of FIG. 1. Similarly, in some embodiments, one or more of the terminal devices 130 to 142 of FIG. 1 and/or the terminal device 212 of FIG. 2 may generate requests or data traffic; and the one or more of the terminal devices may demand services from the network system. The terminal devices in FIGS. 1 and 2 may be stationary or mobile.

In some embodiments, an HF node (e.g., the HF node 206) may include a first computational (e.g., processor) and/or memory (e.g., computer-readable storage media) capacity of resources, and an RF node (e.g., the RF node 208) may include a second computational and/or memory capacity of resources, where the first capacity includes a higher capacity than the second capacity, which mathematically may be expressed as Qₚᵣ(n_{hf})>>Qₚᵣ(n_{rf}), Qₘₑ(n_{hf})>>Qₘₑ(n_{rf}). For example, the HF node 206 may include high processing and memory resources, meanwhile the RF node 208 may include moderate processing and memory resources. As another example, the computing capacity of the processor 232 of the HF node 206 may be two, three, four, 10, 20, or another order of magnitude higher than the computing capacity of the processor 224 of the RF node 208. As yet another example, the amount or the memory capacity of the computer-readable storage media 234 of the HF node 206 may be two, three, four, 10, 20, or another order of magnitude higher than the amount or the capacity of computer-readable storage media 226 of the RF node 208.

In some embodiments, an HF node (e.g., the HF node 206) may be configurable to receive data traffic belonging to, or associated with, one or more requests from one or more terminal devices (e.g., the terminal device 212) or application(s) (e.g., the application(s) 214) of the terminal device. In some embodiments, the HF node can then monitor the data traffic, and determine and/or check whether a threshold of data traffic is met. For example, a computer-readable medium accessible to the HF node may be encoded with instructions for analyzing the data traffic and determining whether a threshold of traffic is met. The threshold may, in some examples, also be stored in the computer-readable storage medium (e.g., in computer-readable storage media 234 of FIG. 2), and/or in another computer-readable storage medium accessible to the HF node. In some embodiments, the threshold of data traffic may be associated with the amount of processing and/or memory resources included and/or utilized by an HF node. For example, a higher amount of memory and/or resources in an HF node may yield a higher threshold. In some embodiments, upon meeting the threshold, the HF node can generate a queue to a first RF node (e.g., the RF node 208), a second RF node (not illustrated in FIG. 2), another RF node(s) (not illustrated in FIG. 2), or a combination thereof. In some embodiments, the HF node can assign one or more factors from a plurality of factors to at least a portion of the data traffic. The factors may include a type of the data traffic, a total amount of the portion of the data traffic, a first amount of the portion of the data traffic accepted by the first RF node, a second amount of the portion of the data traffic accepted by the second RF node, a third amount of the portion of the data traffic accepted by another RF node(s), or combinations thereof. In some embodiments, when the resources of the HF node are saturated, the HF node can selectively migrate the data to the RF nodes. In some cases, the saturation level of the HF node may also be the threshold at which the data traffic level is met. In some cases, the threshold may be, for example, 90%, 80%, or another percentage of the saturation level of the resources (e.g., processor, memory) of the HF node.

In some embodiments, an HF node (e.g., the HF node 206) may group a plurality of virtual network functions (VNFs), where the VNFs may be associated with a request initiated by one or more terminal devices (e.g., the terminal device 212 of FIG. 2) or application(s) (e.g., the application(s) 214) of the terminal device(s). The VNF(s) may be a software implementation of a network function that may be deployable on virtual machine(s) (VM(s)) and other virtual resources. The HF node may group the plurality of the VNFs by considering the dependency requirements. In some embodiments, the VNFs may help remove individual network and/or network security functions out of dedicated and/or specialized hardware devices and into software that may run on, for example, commodity hardware and/or general-purpose nodes. Therefore, it should be appreciated that the HF node 206, the fog layer 202, and/or any of the embodiments of heterogeneous fog architectures described herein can be used by, for example, network service providers, enterprises, etc. In some embodiments, the VNFs can run in VMs or containers. Example VNFs may include virtualized routers, load balancers, directory services, firewalls, WAN optimization, network address translation (NAT) services, and so forth.

In some embodiments, VNFs can help increase network (e.g., network system 100 of FIG. 1, network system 200 of FIG. 2) scalability and/or agility, while also enabling better use of network infrastructure resources, such as processors and/or computer-readable storage media. Other benefits may include reducing power consumption of the fog nodes (e.g., HF node, RF node) and increasing security and available physical space, since VNFs may replace physical hardware. The fog nodes using the VNFs can also result in reduced operational and/or capital expenditures of the fog nodes and/or fog layer (e.g., fog layer 202 of FIG. 2).

FIG. 3 illustrates a diagram of a heterogeneous fog architecture 300 with HF nodes, RF nodes, and terminal devices, in accordance with examples described herein. FIG. 3 is illustrated and/or described in the context of FIGS. 1 and 2. For the sake of clarity, the heterogeneous fog architecture 300 of FIG. 3 may represent portions, or examples, of the fog layer 104 of FIG. 1, the terminal device layer 106 of FIG. 1, and the network system 100 of FIG. 1. The heterogeneous fog architecture 300, however, does not represent or include the cloud layer 102 of FIG. 1.

In some embodiments, the heterogeneous fog architecture 300 may include a cell 302, a cell 304, a cell 306, additional cells, or fewer cells, than what is illustrated in FIG. 3. In some embodiments, each cell may include a region.

In some embodiments, the cell 302 may include an HF node 308, an RF node 314, an RF node 316, an RF node 318, an RF node 320, a terminal device 338, a terminal device 340, a terminal device 342, additional RF nodes, fewer RF nodes, additional terminal devices, or fewer terminal devices than what is illustrated in FIG. 3.

In some embodiments, the cell 304 may include an HF node 310, an RF node 322, an RF node 324, an RF node 326, an RF node 328, a terminal device 344, a terminal device 346, a terminal device 348, additional RF nodes, fewer RF nodes, additional terminal devices, or fewer terminal devices than what is illustrated in FIG. 3.

In some embodiments, the cell 306 may include an HF node 312, an RF node 330, an RF node 332, an RF node 334, an RF node 336, a terminal device 350, a terminal device 352, a terminal device 354, a terminal device 356, additional RF nodes, fewer RF nodes, additional terminal devices, or fewer terminal devices than what is illustrated in FIG. 3.

In some embodiments. The HF node 308 is communicatively coupled to the each of the RF nodes 314 to 320. In some embodiments, the RF nodes 314 to 320 are communicatively coupled to each other. In some embodiments, the HF node 310 is communicatively coupled to the each of the RF nodes 322 to 328. In some embodiments, the RF nodes 322 to 328 are communicatively coupled to each other. In some embodiments, the HF node 312 is communicatively coupled to the each of the RF nodes 330 to 336. In some embodiments, the RF nodes 330 to 336 are communicatively coupled to each other. In some embodiments, the HF nodes 308, 310, and 312 are communicatively coupled to each other. Therefore, in some embodiments, the heterogeneous fog architecture 300 may monitor and/or keep track of the processing and/or memory resources of one, some, or all of the fog nodes in the heterogeneous fog architecture 300 in real-time, near real-time, or time intervals.

In this disclosure, an HF node may be denoted as n_{hf}; the processing resources of the HF node may be denoted as Qₚᵣ(n_{hf}); and the memory resources of the HF node may be denoted as Qₘₑ(n_{hf}). In some embodiments, an HF node may operate as a baseband unit (BBU) pool, which may be collocated with a high-power radio remote head (RRH). Therefore, each HF node may support a wide, or considerably wide, geographical coverage area that can service a plurality of terminal devices. Accordingly, each of the cells 302 to 306 includes a large, or considerably large, cell footprint.

In this disclosure, an RF node may be denoted as n_{rf}; the processing resources of the RF node may be denoted as Qₚᵣ(n_{hf}); and the memory resources of the RF node may be denoted as Qₘₑ(n_{hf}). In some embodiments, an RF node may be collocated with a low-power RRH that receives migrated (e.g., diffused) data traffic from a saturated HF node. The HF node may operate as an umbrella to the RF nodes to avoid coverage nulls. In some embodiments, the high-power RRH may include a first power RRH, and the low-power RRH may include a second power RRH, where the first power RRH may be two, three, four, 10, 20, or another order of magnitude higher than the second power RRH.

For example, consider a geographical area that includes c∈C cells, where each cell c is composed of HF nodes

$${n}_{hf} ∈ {η}_{rf}^{c} ⊆ {N}_{rf}$$

and multiple RF nodes

$${n}_{rf} ∈ {η}_{rf}^{c} ⊆ {N}_{rf} ,$$

and where

$${η}_{hf}^{c} and {η}_{rf}^{c}$$

denote the total number of HF nodes and RF nodes in the cell c, respectively,

$${c}^{-} \{ {η}_{hf}^{c} , {η}_{rf}^{c} \} .$$

In addition, N_{hf} and N_{rf} may denote the total nodes in the network composed of a total of cells C. In some embodiments, each cell may include a single HF node and multiple RF nodes in a tree topology, which may be mathematically expressed as

$${η}_{rf}^{c} ≫ {η}_{hf}^{c} , i . e . , \vert {η}_{hf}^{c} \vert = 1.$$

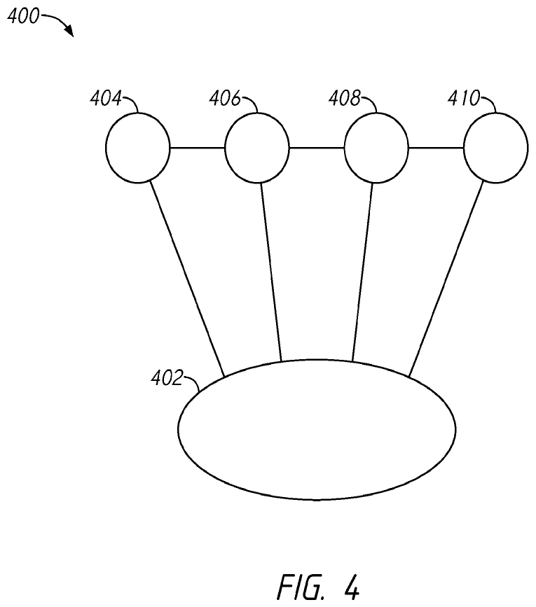

FIG. 4 illustrates a diagram of a quadratic tree 400. The quadratic tree 400 of FIG. 4 may be a portion of the heterogeneous fog architecture 300 of FIG. 3, in accordance with examples described herein. FIG. 4 is illustrated and/or described in the context of FIGS. 1 to 3. For the sake of clarity, the heterogeneous fog architecture 300 of FIG. 3 is illustrated as having three quadratic trees, where a first quadratic tree is located inside the cell 302, a second quadratic tree is located inside the cell 304, and a third quadratic tree is located inside the cell 306. To further clarify, the quadratic tree 400 may represent a portion, or an example, of the fog layer 104 of FIG. 1, the fog layer 202 of FIG. 2, the heterogeneous fog architecture 300 of FIG. 3, and/or the network system 100. The quadratic tree 400, however, does not represent or include a cloud layer or a terminal device layer.

The quadratic tree 400 of FIG. 4 may include an HF node 402, an RF node 404, an RF node 406, an RF node 408, and an RF node 410. In FIG. 4, the HF node 402 may represent the root, the parent, and/or the alpha node of the quadratic tree 400, and the RF nodes 404 to 410 may represent the leaves, the children, and/or the beta nodes of the quadratic tree 400.

In some embodiments, the quadratic tree 400 may be modeled as a graph G in a quadtree data structure, Tr(G)=(N, E), that includes N count of nodes and E count of links. In the quadratic tree 400, the N nodes include all fog nodes and do not include the terminal devices, i.e., N={∀n: n_{hf}∈N_{hf}, n_{rf}∈N_{rf}}, where node n is either an HF node n_{hf}, n_{hf} ∈N_{hf} or an RF node n_{rf}, n_{rf}∈N_{rf}. In this disclosure, the variables N_{hf} and N_{rf} may denote the total number of the HF nodes and the RF nodes, respectively, where N_{rf}>>N_{hf}. For example, the count of RF nodes of the quadratic tree 400 is four times higher than the count of the HF nodes of the quadratic tree 400.

In some embodiments, the set of nodes are interconnected via E count of links (or edges) in the quadratic tree 400, which may be mathematically expressed as E={e: e_{tr-hf}, e_{tr-rf}, e_{hf-rf}, e_{hf-hf}, e_{hf-rf}, e_{rf-rf}}. A link e may be either between a terminal device and an HF node, e_{tr-hf}; a terminal device and an RF node, e_{tr-rf}; the terminal device and an HF and an RF node, e_{hf-rf}; the terminal device and two HF nodes belonging to, for example, two quadratic trees, e_{hf-hf}; and a terminal device and two RF nodes, e_{rf-rf}. In this disclosure, the total number of nodes and links in a cell c may be denoted by N_{c} and E_{c}, respectively, where |E_{c}|=|N_{c}|−1.

The quadratic tree 400 exhibits a height h gauged at the root node (e.g., HF node 402) and the leaf nodes (e.g., RF nodes 404 to 410), as may be mathematically expressed in Equations 1 and 2 of FIG. 13A. In regard to Equations 1 and 2, it can also be said that h∈ [symbol] .

The total number of nodes in a cell (e.g., cell 302, cell 304, or cell 306 of FIG. 3) and/or the quadratic tree 400 of FIG. 4 may be mathematically represented as N_{c}=(4^{h+1}−1)/3. Assuming the quadratic tree 400 is a perfect tree, then the leaf nodes (e.g., RF nodes 404 to 410) may have the same height h(n_{rf}), and the other nodes are full nodes. These leaf nodes (e.g., RF nodes 404 to 410) are separated from the root node (e.g., the HF node 402) by a depth (or distance) d via E_{d} links, d∈ [symbol] , thereby forming the (d)th level of the quadratic tree 400, Tr(G), where this tree may be represented as Tr. In one aspect, the quadratic tree 400 has lower and upper exponential growth rates that may be equal. In another aspect, the quadratic tree 400 may be spherically symmetric, where each vertex of the RF nodes 404 to 410 is located at a distance d from the HF node 402. In yet another aspect, the quadratic tree 400 is finite, which may be mathematically represented as T-convergent {Tr(G). n∈N}.

In some embodiments, the nodes of the heterogeneous fog architecture 300 of FIG. 3 and/or the quadratic tree 400 may be mathematically represented as ∀n∈N−{Nₜᵣ}, where Nₜᵣ denotes the total number of nodes. In some embodiments, the links e between the nodes may be mathematically represented as ∀e∈E. In some embodiments, the heterogeneous fog architecture 300 and/or the quadratic tree 400 include(s) a finite amount of processing and memory resources, where the total processing capacity may be bounded by Qₚᵣ(n), the total memory capacity may be bounded by Qₘₑ(n), and the available bandwidth of the link e may be bounded by B(e).

In some embodiments, the fog nodes ∀ₙ∈N−{Nₜᵣ} can host a single or multiple VNFs from the SFC request of a service type, s∈S, vₛ∈Vᵣ, where S is the total number of VNF types in the request. For the sake of clarity, a request may be associated with an application that may be initiated by a terminal device or an application of the terminal device. The variable Vᵣ represents the set of all demanded VNFs in a request r, according to the dependency in the SFC, as is specified in a request model of a terminal device (“terminal request model”).

In the terminal request model, the fog nodes in each cluster receive data traffic from the terminal devices. In some embodiments, the data traffic may follow a non-homogenous Poisson point process (PPP) density, with an arrival density of λ at the (t)th time step, and a u processing rate at the fog node. Accordingly, the probability density function (PDF) and the cumulative distribution function (CDF) of the response time may be mathematically expressed in Equations 3 and 4, respectively, where the Equations 3 and 4 are shown in FIG. 13A. Meanwhile, the mean response time may be mathematically expressed in Equation 5 shown in FIG. 13A.

In some embodiments, the data traffic may vary in terms of the delay bound (e.g., time-delay requirements), processing requirements (e.g., using one or more fog nodes), memory requirements (e.g., of one or more fog nodes), a count of VNFs in the SFC, a service lifetime (e.g., a total time required to process and/or store the request of the terminal device using the fog nodes), other variables, or combinations thereof. For example, each request r∈R may be represented by an 8-tuple, which may be mathematically expressed as Equation 6 of FIG. 13A. In Equation 6, the variable src∈Nₜᵣ denotes the user terminal (or a source node of the request); the variable dest denotes the destination node (e.g., an HF node), i.e., dest∈N−{Nₜᵣ}; the variable Vᵣ represents the set of all VNFs in the request r, which may be mathematically expressed as Vᵣ={v₁, v₂, v₃, . . . , vₛ}; the dependent and/or sequential relationship between the VNFs may be denoted as Depᵣ, for example, Depᵣ={v₁→v₂→v₃}; the variable αᵣ may define the processing and memory resources that may be needed to map any VNF on the node, for example, αᵣ={∀vₛ∈Vᵣ: Qₚᵣ(vₛ), Qₘₑ(vₛ)}; the variable bᵣ and δᵣ may denote the required link bandwidth interconnecting the VNFs and the end-to-end delay bound, respectively; and the variable ρᵣ may denote the application lifetime for the request, after which the request is dropped from the network (e.g., the heterogeneous fog architecture 300 of FIG. 3, the quadratic tree 400 of FIG. 4), and resources at the nodes (e.g., HF nodes, RF nodes) may be restored to map future requests.

FIGS. 5A and 5B, collectively, show an example pseudocode of an SFC provisioning scheme utilized by an HF node (e.g., HF node 206, HF node 308, HF node 310, HF node 312, HF node 402), in accordance with examples described herein. For example, the pseudocode of FIGS. 5A and 5B may be encoded on instructions 236 of FIG. 2. For the sake of brevity, this disclosure does not describe each line of the pseudocode in exhaustive detail since they are shown in FIGS. 5A and 5B.

In some embodiments, the SFC provisioning scheme shown in FIGS. 5A and 5B detail hosting the incoming requests R over the heterogeneous fog architecture 300 of FIG. 3 and/or the quadratic tree 400 of FIG. 4, Tr(G)=(N, E).

In some embodiments, the HF node of each cell (e.g., cells 302 to 306 of FIG. 3) may implement the SFC provisioning scheme described herein. The heterogeneous fog architecture may first determine the shortest path between the terminal device (or the source src) sending the request and one of the HF nodes of one of the cells of the heterogeneous fog architecture. In addition, the heterogeneous fog architecture may also determine whether the HF node includes the available resources to process and/or store the request. In some embodiments, after a terminal device sends the request, each HF node that receives the request determines their distance from the terminal device. In some embodiments, each HF node checks the availability of the processing and/or storing capacity in the HF node and/or the entire respective cell. The HF nodes may sometimes communicate this data to each other. In some embodiments, the HF node closest to the terminal device also includes the available resources to complete, process, and/or store the request sent by a terminal device. The HF node may then accept the request from the terminal device, as is illustrated in FIG. 5A. Therefore, in some embodiments, the closest and/or freest HF node may perform an SFC provisioning scheme.

In some embodiments, the HF node of each cell of the heterogeneous fog architecture may operate in an active mode. By operating in the active mode, the HF node can continuously check whether one or more terminal devices are sending request(s) to be processed and/or stored using the heterogeneous fog architecture (e.g., using the HF node and/or the RF nodes).

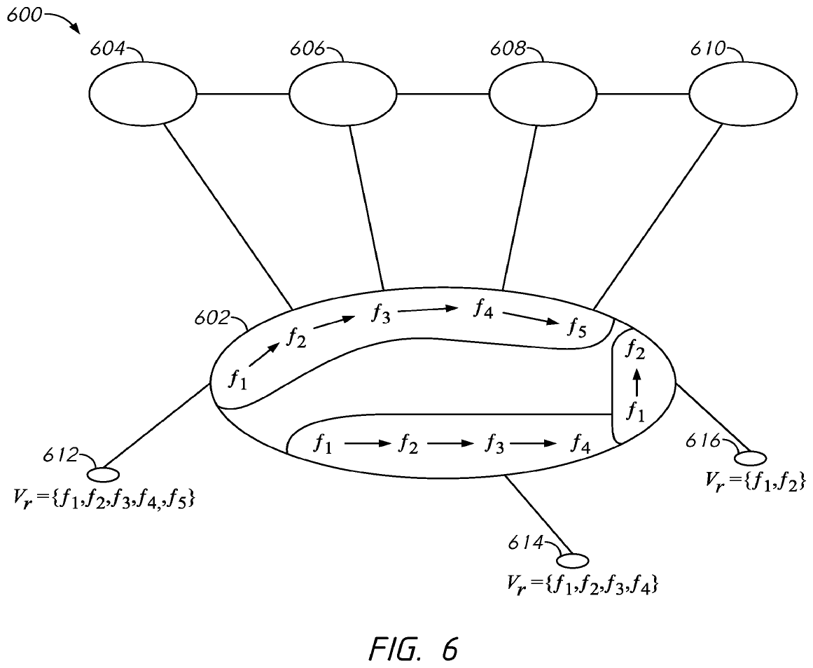

The SFC provisioning scheme may include performing a provisioning on a single HF node (e.g., the HF node 402 of FIG. 4, the closest and/or freest HF node), and the HF node may cluster (or group) all the VNFs in the SFC. In some embodiments, the HF node may cluster the VNFs in the SFC by using, for example, the relationships shown and/or described in relation to Equation 6 of FIG. 13A, or any other criteria, such as those illustrated and/or described in the context of FIGS. 6 to 11. In some embodiments, the SFC provisioning scheme may include keeping the RF nodes (e.g., RF nodes 404 to 410 of FIG. 4) in an idle mode, such as when the RF nodes are not used in processing and/or storing the request of the terminal device. In some embodiments, the SFC provisioning scheme may include operating the RF nodes in an active mode, such as when the RF nodes process and/or store part, or the whole, of the request of the terminal device. Note that the idle mode of operation decreases an amount of energy used by one or more of the RF nodes and/or the heterogeneous fog architecture. The RF nodes can support the HF node when processing and/or memory resources of the HF node are saturated. Therefore, the RF nodes operate as backup nodes of, for example, the HF node 402, when the data traffic in the quadratic tree 400 of FIG. 4 and/or the heterogeneous fog architecture 300 of FIG. 3 increases.

In some embodiments, the clustered or grouped mapping of the VNFs can reduce the signaling overhead over backhaul links between the HF nodes and the RF nodes. Therefore, this SFC provisioning scheme can embed requests R, which may be initiated by an application (e.g., application(s) 214) of a terminal device (e.g., terminal device 212), to the closest HF node to the terminal device. By so doing, this SFC provisioning scheme can yield a lower time delay of processing and/or storing the request R. In some embodiments, the time delay may include a first time to migrate data from a terminal device to a host node (e.g., an HF node), where the data are associated with the requests and/or the application of the terminal device: a second time associated with the processing and/or storing of the plurality of VNFs associated with the SFC provisioning; and a third time to migrate the processed plurality of the VNFs from the host node to the terminal device.

In some embodiments, the SFC provisioning scheme includes checking whether the host node (e.g., an HF node), n̅, n̅=(n̅_{hf}∨n̅_{rf}), includes sufficient processing and/or memory resources that exceed the required processing and/or storing capacities of the incoming requests from a terminal device, as may be mathematically expressed in Equations 7 and 8 of FIG. 13A. With regard to Equations 7 and 8, index j∈J relates to the location of VNF vₛ in the dependency array of Vᵣ, i.e., J is the location of the last VNF in the chain.

In some embodiments, the SFC provisioning scheme checks whether the available link bandwidth B(e) over the substrate link includes sufficient bandwidth that exceeds the requested bandwidth bᵣ. By so doing, the SFC provisioning scheme can ensure that the incoming data traffic can be hosted at, for example, the HF node without congestion and/or saturation, as may be mathematically expressed in Equation 9 of FIG. 13B.

In some embodiments, the SFC provisioning scheme may check whether the aggregated link delay D(e) between a terminal device and a selected host node (e.g., HF node), n̅, along with, or plus, the time delay it takes the host node to process and/or store the request may not exceed the request delay bound, δᵣ, as may be mathematically expressed in Equation 10 of FIG. 13B.

In some embodiments, the SFC provisioning scheme may include or utilize an objective function γ; which can reduce loads among nodes, and which can lower link delays, as may be mathematically expressed using Equation 11 of FIG. 13B. In Equation 11, D(src, n_{hf}) may denote the link time delay between the source src (e.g., a terminal device) and a host node (e.g., an HF node); n_{hf}∈N_{hf}, W(n_{hf}) may denote the weight assigned to the host node; and W(e) may denote the weight assigned to the link connecting to the host nodes. In some embodiments, the node weight may be gauged using W(n_{hf})=|Vₘₐₚ|/|Vᵣ|, where Vₘₐₚ denotes the set of successfully mapped VNFs, |Vₘₐₚ| denotes the number of VNFs mapped onto the node, and |Vᵣ| denotes the number of VNFs in the request.

In some embodiments, the SFC provisioning scheme may map the first VNF in the SFC Vᵣ[0] on the host HF node, ň_{sf}. Then, the SFC provisioning scheme may include updating the processing and memory resources and the HF node, as may be mathematically expressed by Qₚᵣ(ň_{hf})=Qₚᵣ(ň_{hf})−Qₚᵣ(vₛ) and Qₘₑ(ň_{hf})=Qₘₑ(ň_{hf})−Qₘₑ(vₛ), respectively.

In some embodiments, the SFC provisioning scheme may include examining Depᵣ to map the subsequent VNF in the SFC, after which the processing and memory resources of the HF node may be updated. This SFC provisioning scheme continues for all VNFs in the SFC for all r∈R, as may be mathematically expressed in Equation 12 of FIG. 13B.

In some embodiments, once all the VNFs in the SFC are mapped, a counter variable is initiated, Counterᵣ, which records the service time. For the sake of clarity, the mapping of the VNFs in the SFC may be completed using the instructions 236 of the HF node 206 of FIG. 2, and the mapping may be recorded and/or stored in the computer-readable storage media 234 of the HF node 206 of FIG. 2. In some embodiments, the value of Counterᵣ may also be stored in the computer-readable storage media 234 of the HF node 206. When the request lifetime is evolved, Counterᵣ=ρᵣ, then the request may be dropped from the network (e.g., the heterogeneous fog architecture 300 of FIG. 3, the quadratic tree 400 of FIG. 4), and the processing and memory resources of the host node (e.g., an HF node, the HF node 206) may be freed to accommodate different requests from the same terminal device and/or another terminal device.

In some embodiments, the SFC provisioning scheme may include mapping the grouped VNFs on one host node (e.g., the HF node 402), while deactivating or idling all other nodes (e.g., the RF nodes 404 to 410) in the network and/or fog architecture (e.g., the quadratic tree 400) to achieve reduced link delays, as well as energy savings. However, at one stage, the processing and/or memory resources at the host load may become exhausted, when the HF node reaches a saturation threshold ß(n_{hf}). Therefore, in some embodiments, an HF node (e.g., HF node 206) continues mapping VNFs until an upper threshold level of the processing and/or memory resources of the HF node is reached. The upper threshold level of the processing and/or memory resources may be 100%, 90%, 80%, or another percentage of the available processing (e.g., processor 232 of FIG. 2) and/or memory (e.g., computer-readable storage media 234 of FIG. 2) resources. After the upper threshold level is reached, the HF node redirects, migrates, and/or diffuses from the HF node (e.g., HF node 402) to the RF nodes (e.g., RF nodes 404 to 410) in the tree (e.g., quadratic tree 400). In some embodiments, the HF node redirects, migrates, and/or diffuses using a heat diffusion structure. For example, the HF node may start to redirect, migrate, and/or diffuse the load gradually when ∃_{L}_{_{T}}(n)≥σ(n) to the neighboring (and upper tier) RF nodes, so that the RF nodes can start hosting VNFs. This SFC provisioning scheme may be based on a load migration mechanism, when the utilization rate reaches a threshold level, as may be expressed in Equation 13 of FIG. 13B.

FIG. 6 illustrates a diagram of a heterogeneous fog architecture 600 that includes a HF node having a relatively low utilization rate, in accordance with examples described herein. A low utilization rate may be defined by an operator of the heterogeneous fog architecture 600, and the low utilization rate may be at or below, for example, 80%, 70%, 60%, or another percentage of the capacity of the processor and/or memory of the HF node.

FIG. 6 is illustrated and/or described, at least in part, in the context of FIGS. 1 to 5B. For example, the heterogeneous fog architecture 600 of FIG. 6 may be a portion of the heterogeneous fog architecture 300 of FIG. 3, and the heterogeneous fog architecture 300 of FIG. 3 may be a portion of the network system 100 of FIG. 1. For the sake of clarity, the heterogeneous fog architecture 600 does not represent an example of (or does not include) the cloud layer 102 of FIG. 1

In some embodiments, the heterogeneous fog architecture 600 of FIG. 6 may include an HF node 602, an RF node 604, an RF node 606, an RF node 608, an RF node 610, a terminal device 612, a terminal device 614, and a terminal device 616. It is to be understood that the heterogeneous fog architecture 600 may include fewer or additional terminal devices.

In some embodiments, the HF node 602 node may receive data traffic from incoming requests from the terminal devices 612, 614, 616. Note that the terminal device 612, 614, or 616 may include or utilize an application, and the application may send the requests to the HF node 602. For example, the terminal device 612 may initiate a first request, where Vᵣ={f₁, f₂, f₃, f₄, f₅}; the terminal device 614 may initiate a second request, where Vᵣ={f₁, f₂, f₃, f₄}; and the terminal device 616 may initiate a third request, where Vᵣ={f₁, f₂,}. As is illustrated in FIG. 6, the HF node 602 clusters or groups the VNFs that are associated with each request.

In some embodiments, due to relatively few requests from the terminal devices 612, 614, and 616, the HF node 602 may have a low utilization rate, or a utilization rate below a threshold utilization capacity. In such a case, the HF node 602 processes and/or stores all the VNFs associated with the requests of the terminal devices and/or the applications of the terminal devices. To that end, the HF node 602 operates in an active mode, while the RF nodes 604 to 610 are kept in an idle mode. For the sake of clarity, in the scenario of the heterogeneous fog architecture 600 of FIG. 6, the RF nodes 604 to 610 are not utilized to process and/or store the various requests from the terminal devices 612, 614, and 616. Nevertheless, the RF nodes 604 to 610 can serve as backup nodes, should the process and/or memory resources of the HF node 602 become saturated (not illustrated as such in FIG. 6).

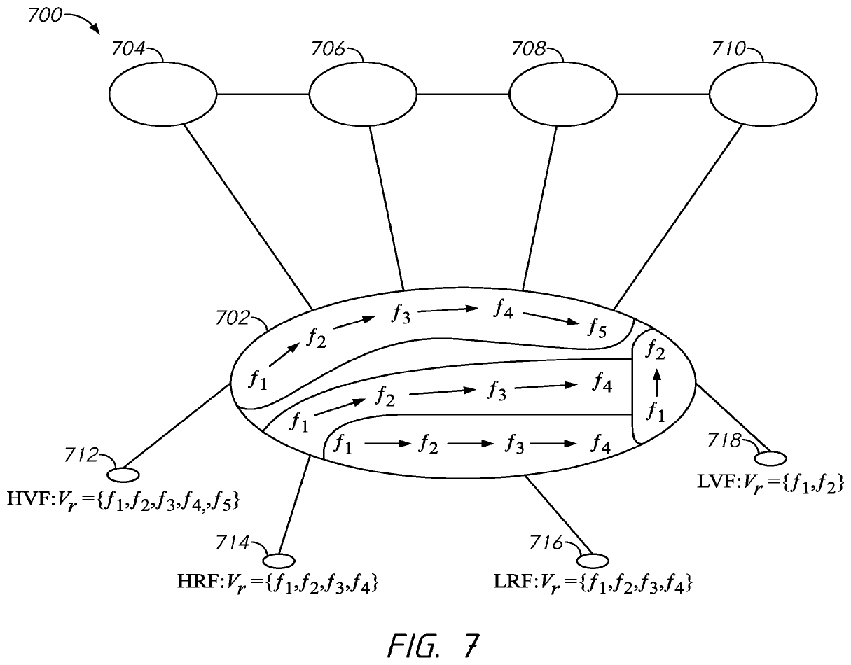

FIG. 7 illustrates a diagram of a heterogeneous fog architecture 700 that includes a HF node 702 having a high utilization rate, in accordance with examples described herein. FIG. 7 is illustrated and/or described, at least in part, in the context of FIGS. 1 to 6. The high utilization rate may be defined by an operator of the heterogeneous fog architecture 700, and the high utilization rate may be at or above, for example, 90%, 80%, 70%, 60%, or another percentage of the capacity of the processor and/or memory of the HF node.

In some embodiments, the heterogeneous fog architecture 700 may include the HF node 702, an RF node 704, an RF node 706, an RF node 708, an RF node 710, a terminal device 712, a terminal device 714, a terminal device 716, and a terminal device 718. It is to be understood that the heterogeneous fog architecture 700 may include fewer or additional terminal devices.

In some embodiments, the terminal devices and/or the applications of the terminal devices may send requests, where the requests may include different attributes and/or characteristics, such as a load type, a workload type, a VNF type, etc. Examples of such attributes and/or characteristics may include high (or highest) resources first (“HRF”); low (or lowest) resources first (“LRF”); high (or highest) VNFs first (“HVF”) (e.g., highest count of VNFs first); and low (or lowest) VNFs first (“LVF”) (e.g., lowest count of VNFs first). In some embodiments, the resources may be the processor 224 of FIG. 2, the computer-readable storage media 226 of FIG. 2, the processor 232 of FIG. 2, the computer-readable storage media 234 of FIG. 2, the processor 216 of FIG. 2, the computer-readable storage media 218 of FIG. 2, other resources not explicitly illustrated in FIG. 2, or combinations thereof. To that end, the heterogeneous fog architecture 700 may be configured to monitor, determine, differentiate, and/or categorize these requests depending on the attributes or the characteristics of the requests.

In some embodiments, the HF node 702 may receive data traffic from incoming requests from the terminal devices. For example, the terminal device 712 may initiate a first request, and the HF node 702 may determine, differentiate, and/or categorize the first request as being an HVF, where HVF: Vᵣ={f₁, f₂, f₃, f₄, f₅}. As another example, the terminal device 714 may initiate a second request, and the HF node 702 may determine, differentiate, and/or categorize the second request as being an HRF, where HRF: Vᵣ={f₁, f₂, f₃, f₄}. As another example, the terminal device 716 may initiate a third request, and the HF node 702 may determine, differentiate, and/or categorize the third request as being an LRF, where LRF: Vᵣ={f₁, f₂, f₃, f₄}. As yet another example, the terminal device 718 may initiate a fourth request, and the HF node 702 may determine, differentiate, and/or categorize the fourth request as an LVF, where LVF: Vᵣ={f₁, f₂,}. As illustrated in FIG. 7, the HF node 702 clusters or groups the VNFs associated with each request.

In some embodiments, the terminal device may send a high count of requests, with a high processing requirement, and/or with a high storage requirement. In such a case, the HF node 702 will have a high utilization rate, or a utilization rate at or above a threshold utilization capacity. Therefore, the HF node 702 may be a saturated HF node. In the heterogeneous fog architecture 700, the HF node 702 operates in an active mode, and as the HF node 702 reaches saturation, the RF nodes 704 to 710 switch from an idle mode to an active mode. By so doing, the RF nodes 704 to 710 can serve as backup nodes.

In some embodiments, as an HF node (e.g., the HF node 702) approaches the utilization threshold, the HF node starts to diffuse the load (e.g., task migration) to the least-loaded, or lower-loaded, neighboring RF nodes in the cell (e.g., cell 302, cell 304, cell 306) and/or the heterogeneous fog architecture (e.g., heterogeneous fog architecture 700). For the sake of clarity, the HF node (e.g., the HF node 702 of FIG. 7, the HF node 206 of FIG. 2) may use the instructions 236 of FIG. 2 to determine whether the utilization rate has reached a threshold of the processor 232 of FIG. 2 and/or the computer-readable storage media 234 of FIG. 2. In some embodiments, the HF node may utilize a heat diffusion principle for the migration process, where the HF node may transmit the load gradually, or near-gradually, to the neighboring RF nodes that have a common link over k∈K iterations in T time steps. The load migration includes determining the type and/or the amount of load (e.g., VNFs) to migrate along each edge. Therefore, in some embodiments, the HF node may reduce the load on the HF node by migrating the load to the RF nodes, while maintaining the least (or a lower) energy consumption, the least (or a lower) time delay, and/or the least (or a lower) cost in the heterogeneous fog architecture and/or the network. The load in each cell may be gauged by the count of nodes in the cell and their associated loads.

In some embodiments, an HF node (e.g., the HF node 702) may be configured to determining a type of each VNF of the plurality of VNFs in an SFC associated with a request of a terminal device or an application of the terminal device. In some embodiments, based on the type of each VNF of the plurality of VNFs, the HF node may select a migration scheme of a plurality of migration schemes (e.g., the HRF, LRF, HVF, LVF migration schemes).

In some embodiments, a saturated HF node (e.g., HF node 702)

$${\check{n}}_{hf}^{max}$$

may migrate the load to all RF nodes (e.g., RF nodes 704 to 710) that are in the proximity of the HF node,

$$∀ {n}_{rf} ∈ nbr ( {\check{n}}_{hf}^{max} ) ,$$

through link

$$e ( {\check{n}}_{hf}^{max} , {n}_{rf} ) ,$$

and the migration of the load may be mathematically represented by a data traffic flow

$$F ( {\check{n}}_{hf}^{max} \to ∀ {n}_{rf} \vert ∀ {n}_{rf} ∈ nbr ( {\check{n}}_{hf}^{max} ) ) .$$

In order to gauge the simultaneous, or the near-simultaneous, flow of the data traffic using each link, the HF node may create a proximity list that includes the neighboring nodes. Then, the HF node may determine, differentiate, and/or categorize the type of load that needs to be migrated, the total amount of load that needs to be migrated, and specific amount(s) of load(s) that needs to be migrated to each RF node, meanwhile the heterogeneous fog architecture can achieve load balancing and distribution fairness throughout the fog nodes.

In some embodiments, the HF node may create the proximity list by including the RF nodes that have a shared link with the HF node. For example, if a direct link exists between the saturated HF node

$${\check{n}}_{hf}^{max}$$

and any RF node n_{rf}, i.e., if a link is incident on

$${\check{n}}_{hf}^{max}$$

and n_{rf}, i.e.,

$$e ( {\check{n}}_{hf}^{max} , {n}_{rf} ) ∈ E ( G ) ,$$

then the saturated HF node

$${\check{n}}_{hf}^{max}$$

and any RF node n_{rf} are neighboring nodes in a cell and/or in the heterogeneous fog architecture. By contrast, if

$$e ( {\check{n}}_{hf}^{max} , {n}_{rf} ) ∉ E ( G ) ,$$

then the nodes are indirectly connected, nonadjacent nodes, or non-neighboring nodes.

In some embodiments, the adjacent nodes of the HF node or the saturated HF node

$${\check{n}}_{hf}^{max}$$

may be stored in a boundary list

$$nbr ( {\check{n}}_{hf}^{max} ) = \{ ∀ {n}_{rf} ∈ N \vert ∃ e ( {\check{n}}_{hf}^{max} , {n}_{rf} ) ∈ E \} .$$

The degree of the HF node or the saturated HF node

$${\check{n}}_{hf}^{max}$$

may represent the count of links incident to the RF nodes, for example, determined by the cardinality of the open neighborhood as

$$deg ( {\check{n}}_{hf}^{max} ) = \vert nbr ( {\check{n}}_{hf}^{max} ) \vert .$$

The minimum and maximum degrees of the graph may be mathematically expressed using Equations 14 and 15 of FIG. 13B.

In some embodiments, a saturated HF node (e.g., HF node 702) may compute a boundary list, and the saturated HF node migrates, transfers, or diffuses the load equally (or near-equally) and synchronously (or near synchronously) to the RF nodes in the tree (e.g., the quadratic tree 400).

In some embodiments, the saturated HF node (e.g., HF node 702) may determine the load type, or the VNF type, to be migrated to the RF nodes. The HF node may determine a type of each VNF of the plurality of VNFs. In some embodiments, based on the type of each VNF of the plurality of VNFs, the HF node may select a migration scheme of a plurality of migration schemes. In some embodiments, the HF node may utilize an HRF migration scheme. In some embodiments, the HF node may utilize an LRF migration scheme. In some embodiments, the HF node may utilize an HVF migration scheme. In some embodiments, the HF node may utilize an LVF migration scheme.

In some embodiments, a saturated HF node may select one of the plurality of migration schemes, in part, based on the VNF processing and/or memory resource requirements, the number of VNFs in the chain, and/or the time-delay requirements to process and/or store a request from an application of a terminal device. In some embodiments, the processing requirements or characteristics, needed by the heterogeneous fog architecture to complete the request, may include one of measures of: a processing speed of one, some, or all of the fog nodes in the heterogeneous fog architecture; a processing power of one, some, or all of the fog nodes in the heterogeneous fog architecture; an amount of memory of one, some, or all of the fog nodes in the heterogeneous fog architecture; a data traffic intensity of one, some, or all of the fog nodes in the heterogeneous fog architecture; or combinations thereof.

In some embodiments, a saturated HF node utilizes a migration scheme that may yield a lowest, or a lower, SFC request blocking rate. By so doing, the HF node helps increase a revenue of an owner or operator of the heterogeneous fog architecture, increase the QoS, increase end-user satisfaction, decrease costs associated with the heterogeneous fog architecture, and provides other benefits. In some embodiments, a set of mapped VNFs on the HF node may be denoted by Vₘₐₚ(n_{hf})={Vᵣ}, and the HF node can reorder the mapped VNFs V̅ based on a criteria, which may be mathematically expressed as Vₘₐₚ→V̅.

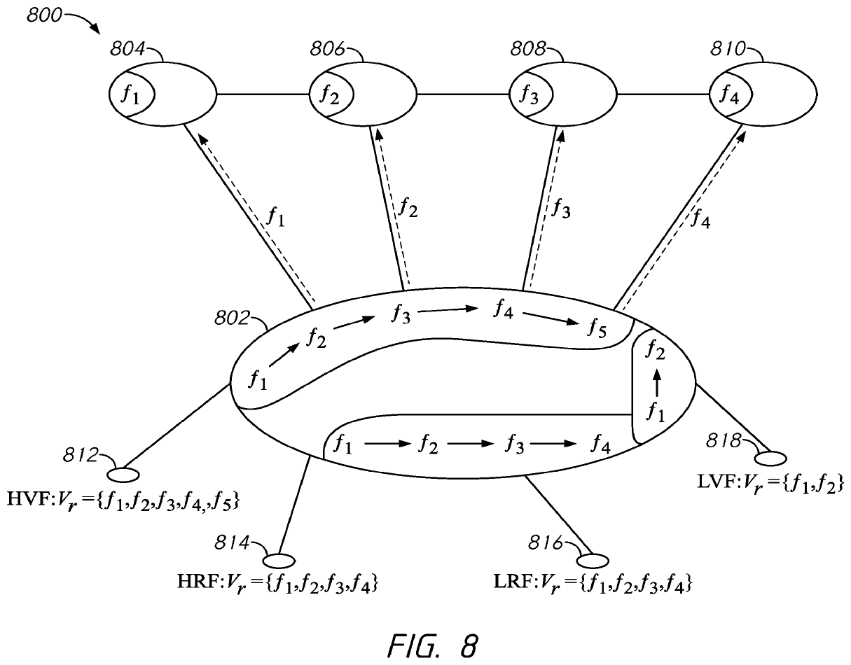

FIG. 8 illustrates a diagram of a heterogeneous fog architecture 800 that includes a HF node that utilizes an HRF migration scheme to migrate data from the HF node to RF nodes of the heterogeneous fog architecture, in accordance with examples described herein. FIG. 8 is illustrated and/or described, at least in part, in the context of FIGS. 1 to 7.

In some embodiments, the heterogeneous fog architecture 800 may include an HF node 802, an RF node 804, an RF node 806, an RF node 808, an RF node 810, a terminal device 812, a terminal device 814, a terminal device 816, and a terminal device 818. It is to be understood that the heterogeneous fog architecture 800 may include fewer or additional terminal devices.

In some embodiments, the HF node 802 may receive data traffic from incoming requests from the terminal devices. For example, the terminal device 812 may initiate a first request, and may determine, differentiate, and/or categorize the first request as being an HVF, where HVF: Vᵣ={f₁, f₂, f₃, f₄, f₅}. As another example, the terminal device 814 may initiate a second request, and the HF node 802 may determine, differentiate, and/or categorize the second request as being an HRF, where HRF: Vᵣ={f₁, f₂, f₃, f₄}. As another example, the terminal device 816 may initiate a third request, and the HF node 802 may determine, differentiate, and/or categorize the third request as being an LRF, where LRF: Vᵣ={f₁, f₂, f₃, f₄}. As yet another example, the terminal device 818 may initiate a fourth request, and the HF node 802 may determine, differentiate, and/or categorize the fourth request as an LVF, where LVF: Vᵣ={f₁, f₂}.

In some embodiments, the HF node 802 uses the HRF scheme to sort the mapped requests on the saturated HF node (e.g., HF node 702 of FIG. 7), in order to decrease processing and/or memory resource requirements. By so doing, the HRF migration scheme can be used to rapidly free resources at the HF node (e.g., HF node 802 of FIG. 8). The freed resources at the HF node 802 may increase the capacity and admission ratio at the expense of increased latency for the highest computation requests that may be migrated, as may be mathematically expressed in Equation 16 of FIG. 13C.

For the sake of clarity, comparing the heterogeneous fog architecture 700 of FIG. 7 to the heterogeneous fog architecture 800 of FIG. 8, the VNFs (i.e., HRF: Vᵣ={f₁, f₂, f₃, f₄}) that are associated with the request sent by the terminal device 814 are no longer in the HF node 802. As is illustrated in FIG. 8, the HF node 802 can migrate the VNFs to the RF nodes. Specifically, the HF node 802 migrates f₁ to the RF node 804, f₂ to the RF node 806, f₃ to the RF node 808, and f₄ to the RF node 810, so that these RF nodes can process and/or store the requests associated with these VNFs. By so doing, the HF node 802 frees some or all of its processing and/or memory resources to accept other requests.

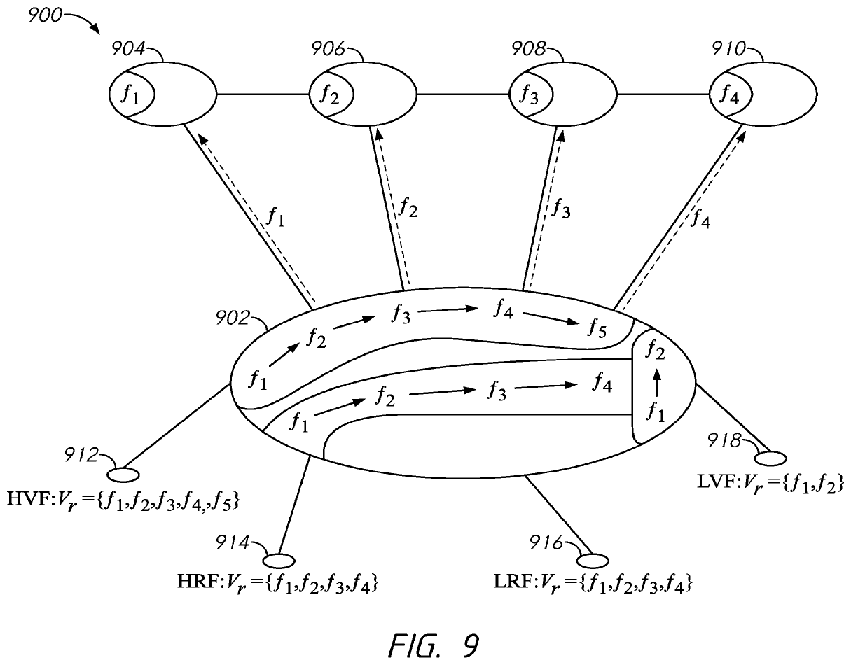

FIG. 9 illustrates a diagram of a heterogeneous fog architecture 900 that includes a HF node 902 that utilizes a LRF migration scheme to migrate data from the HF node to RF nodes of the heterogeneous fog architecture, in accordance with examples described herein. FIG. 9 is described and/or illustrated, at least in part, in the context of FIGS. 1 to 8.

In some embodiments, the heterogeneous fog architecture 900 may include an HF node 902, an RF node 904, an RF node 906, an RF node 908, an RF node 910, a terminal device 912, a terminal device 914, a terminal device 916, and a terminal device 918. It is to be understood that the heterogeneous fog architecture 900 may include fewer or additional terminal devices.

In some embodiments, the HF node 902 may receive data traffic from incoming requests from the terminal devices. For example, the terminal device 912 may initiate a first request, and the HF node 902 may determine, differentiate, and/or categorize the first request as being an HVF, where HVF: Vᵣ={f₁, f₂, f₃, f₄, f₅}. As another example, the terminal device 914 may initiate a second request, and the HF node 902 may determine, differentiate, and/or categorize the second request as being an HRF, where HRF: Vᵣ={f₁, f₂, f₃, f₄}. As another example, the terminal device 916 may initiate a third request, and the HF node 902 may determine, differentiate, and/or categorize the third request as being an LRF, where LRF: Vᵣ={f₁, f₂, f₃, f₄}. As yet another example, the terminal device 918 may initiate a fourth request, and the HF node 902 may determine, differentiate, and/or categorize the fourth request as an LVF, where LVF: Vᵣ={f₁, f₂,}.

In some embodiments, the HF node 902 utilizes the LRF migration scheme in an increasing order, starting with the first lowest, the second lowest, and so forth. By so doing, in some embodiments, the HF node 902 lowers the fragmentation of the requests. In some embodiments, the HF node 902 increases the possibility, or allows for the probability, for less migration frequencies for requests mapped on the HF node 902. In some embodiments, when the HF node 902 utilizes the LRF migration scheme to migrate data from to the RF nodes 904 to 910, the saturation of the processing and/or memory resources at the RF nodes may be avoided. In some embodiments, the LRF migration scheme may help reduce the burden on the links bandwidth during the early migration stage, particularly if the arrival rate at the HF node 902 is high, or relatively high. By so doing, the LRF migration scheme can help reduce the bandwidth fragmentation on the network links, thereby allowing additional requests to be processed with, and/or stored in, the heterogeneous fog architecture 900, as may be expressed in Equation 17 of FIG. 13C.

For the sake of clarity, comparing the heterogeneous fog architecture 700 of FIG. 7 to the heterogeneous fog architecture 900 of FIG. 9, the VNFs (i.e., LRF: Vᵣ—{f₁, f₂, f₃, f₄}) that are associated with the request sent by the terminal device 916 are no longer in the HF node 902. As is illustrated in FIG. 9, the HF node 902 can migrate the VNFs to the RF nodes 904 to 910. Specifically, the HF node 902 migrates f₁ to the RF node 904, f₂ to the RF node 906, f₃ to the RF node 908, and f₄ to the RF node 910, so that these RF nodes can process and/or store the requests associated with these VNFs. By so doing, the HF node 902 frees some of its resources to accept other requests.

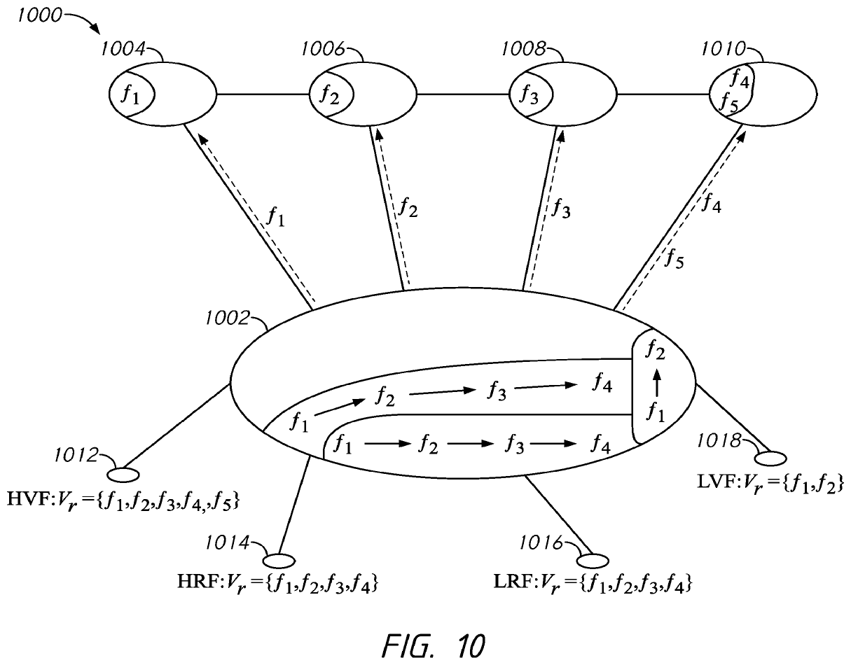

FIG. 10 illustrates a diagram of a heterogeneous fog architecture 1000 that includes a HF node 1002 that utilizes an HVF migration scheme to migrate data from the HF node to RF nodes of the heterogeneous fog architecture 1000, in accordance with examples described herein. FIG. 10 is described and/or illustrated, at least in part, in the context of FIGS. 1 to 9.

In some embodiments, the heterogeneous fog architecture 1000 may include an HF node 1002, an RF node 1004, an RF node 1006, an RF node 1008, an RF node 1010, a terminal device 1012, a terminal device 1014, a terminal device 1016, and a terminal device 1018. It is to be understood that the heterogeneous fog architecture 1000 may include fewer or additional terminal devices.

In some embodiments, the HF node 1002 may receive data traffic from incoming requests from the terminal devices. For example, the terminal device 1012 may initiate a first request, and the HF node 1002 may determine, differentiate, and/or categorize the first request as being an HVF, where HVF: Vᵣ—{f₁, f₂, f₃, f₄, f₅}. As another example, the terminal device 1014 may initiate a second request, and the HF node 1002 may determine, differentiate, and/or categorize the second request as being an HRF, where HRF: Vᵣ={f₁, f₂, f₃, f₄}. As another example, the terminal device 1016 may initiate a third request, and the HF node 1002 may determine, differentiate, and/or categorize the third request as being an LRF, where LRF: Vᵣ={f₁, f₂, f₃, f₄}. As yet another example, the terminal device 1018 may initiate a fourth request, and the HF node 1002 may determine, differentiate, and/or categorize the fourth request as an LVF, where LVF: Vᵣ={f₁, f₂,}.

In some embodiments, the HF node 1002 utilizes the HVF migration scheme in a decreasing average VNF number, starting with the first highest, the second highest, and so forth, as may be expressed using Equation 18 of FIG. 13C.

For the sake of clarity, comparing the heterogeneous fog architecture 700 of FIG. 7 to the heterogeneous fog architecture 1000 of FIG. 10, the VNFs (i.e., HVF: Vᵣ={f₁, f₂, f₃, f₄, f₅}) that are associated with the request sent by the terminal device 1012 are no longer in the HF node 1002. As is illustrated in FIG. 10, the HF node 1002 can migrate the VNFs to the RF nodes 1004 to 1010. Specifically, the HF node 1002 migrates f₁ to the RF node 1004, f₂ to the RF node 1006, f₃ to the RF node 1008, and f₄ and f₅ to the RF node 1010, so that these RF nodes can process and/or store the requests associated with these VNFs. By so doing, the HF node 1002 frees some of its resources to accept other requests.

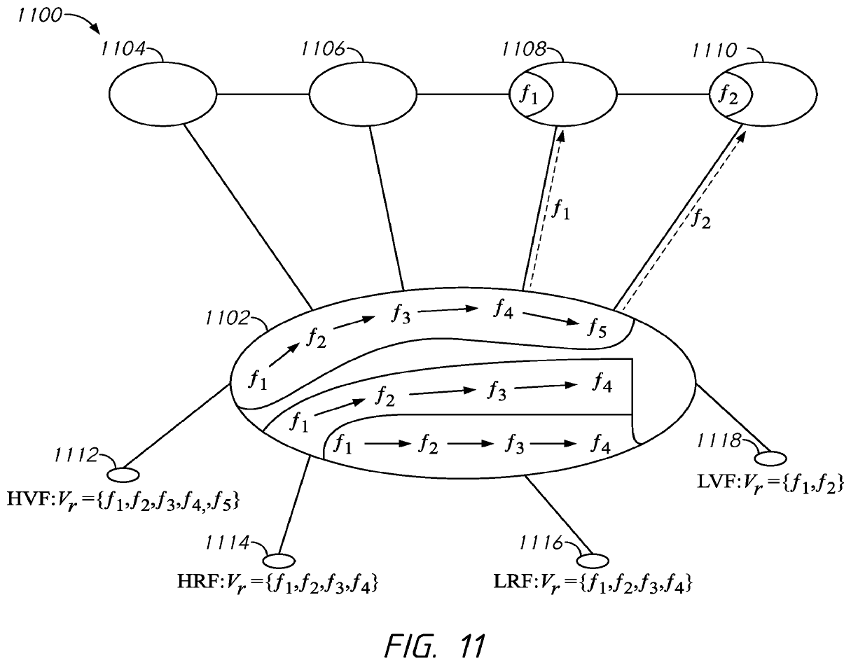

FIG. 11 illustrates a diagram of a heterogeneous fog architecture 1100 that includes a HF node 1102 that utilizes an LVF migration scheme to migrate data from the HF node to RF nodes of the heterogeneous fog architecture 1100, in accordance with examples described herein. FIG. 11 is described and/or illustrated, at least in part, in the context of FIGS. 1 to 10.

In some embodiments, the heterogeneous fog architecture 1100 may include the HF node 1102, an RF node 1104, an RF node 1106, an RF node 1108, an RF node 1110, a terminal device 1112, a terminal device 1114, a terminal device 1116, and a terminal device 1118. It is to be understood that the heterogeneous fog architecture 1100 may include fewer or additional terminal devices.

In some embodiments, the HF node 1102 may receive data traffic from incoming requests from the terminal devices. For example, the terminal device 1112 may initiate a first request, and the HF node 1102 may determine, differentiate, and/or categorize the first request as being an HVF, where HVF: Vᵣ={f₁, f₂, f₃, f₄, f₅}. As another example, the terminal device 1114 may initiate a second request, and the HF node 1102 may determine, differentiate, and/or categorize the second request as being an HRF, where HRF: Vᵣ={f₁, f₂, f₃, f₄}. As another example, the terminal device 1116 may initiate a third request, and the HF node 1102 may determine, differentiate, and/or categorize the third request as being an LRF, where LRF: Vᵣ={f₁, f₂, f₃, f₄}. As yet another example, the terminal device 1118 may initiate a fourth request, and the HF node 1102 may determine, differentiate, and/or categorize the fourth request as an LVF, where LVF: Vᵣ={f₁, f₂,}.

In some embodiments, the HF node 1102 may use the LVF migration scheme in an order of an increasing average VNF count, starting with the first lowest count, the second lowest count, and so forth, as may be mathematically expressed in Equation 19 of FIG. 13C. In some embodiments, the HF node 1102 migrates requests with least number of interconnected VNFs in the request, as is illustrated in FIG. 11. In some embodiments, the LVF migration scheme may help free processing and/or memory resources from the HF node 1102 at reduced migration frequencies by offloading fewer requests to the RF nodes in less iterations. In some embodiments, the LVF migration scheme can reduce the blocking rate of other incoming requests from the terminal devices.

For the sake of clarity, comparing the heterogeneous fog architecture 700 of FIG. 7 to the heterogeneous fog architecture 1100 of FIG. 11, the VNFs (i.e., LVF: Vᵣ={f₁, f₂}) that are associated with the request sent by the terminal device 1118 are no longer in the HF node 1102. The HF node can then migrate these VNFs to the RF nodes. Specifically, as is illustrated in FIG. 11, the HF node 1102 may migrate f₁ to the RF node 1108, and f₂ to the RF node 1110, so that these RF nodes can process and/or store the requests associated with these VNFs. By so doing, the HF node 1102 frees some of its resources to accept other requests.

FIGS. 12A and 12B, collectively, show an example pseudocode for migrating data traffic from a HF node to one or more RF nodes, in accordance with examples described herein. FIGS. 12A and 12B may be described and/or illustrated in the context of FIGS. 1 to 11. For the sake of brevity, this disclosure does not describe each line of the pseudocode in exhaustive detail since the lines of the pseudocode are shown in FIGS. 12A and 12B.

In some embodiments, an HF node can determine the amount of the diffused load that was transferred from the HF node to the neighboring RF nodes in the

$$nbr ( {\check{n}}_{hf}^{max} )$$

at iteration k+1, as is, collectively, shown in FIGS. 12A and 12B.

In some embodiments, an HF node may use a dynamic thresholding mechanism that varies the amount of the migrated load, based on, at least, the arrival rate of the request, a processing rate at the HF node, a lifetime of the request, a link utilization interconnecting e_{hf-rf}, the available processing and/or memory resources at the RF nodes, or combinations thereof. For example, the diffusion amount may be a moderate amount at low incoming requests at the HF node, and this amount may increase at high traffic volumes to avoid full saturation at the HF node, which may be mathematically expressed using Equation 20 of FIG. 13C.

In Equation 20,

$${L}_{mig}^{tot}$$

denotes the total migrated load, and L_{req}(R_{f}) denotes the required resources (e.g., processor, memory, processor 232 of FIG. 2, computer-readable storage media 234 of FIG. 2) for the incoming requests in the (t)th time step. This may be controlled by the arrival rate of incoming requests λ(r), the processing rate φ(n_{hf}) at the HF node, and the occupancy lifetime Dᵣ. The migrated load may also depend on the available link bandwidth interconnecting with the leaf or neighboring RF nodes β(e_{hf-rf}), i.e., 0≤β(e_{hf-rf})≤1, where 0 and 1 indicate available and occupied bandwidths at the interconnecting links e_{hf-rf}, respectively. In some embodiments, a high arrival rate of data traffic may be assumed, which may surpass the processing rate at the HF node. Therefore, the pseudocode of FIGS. 12A and 12B may help the HF node manage a worst-case operating scenario in the network, where the input rate of the data traffic entering the HF node is higher than the output rate of the data traffic exiting the HF node. In such a scenario, the network may be saturated, for example, at the HF node. In Equation 20 of FIG. 13C, Qₐᵥₐᵢₗ(n_{rf}) represents the available processing capacity at the RF node(s).

In some embodiments, the VNFs that compose, or are included in, the SFC can be partitioned to be migrated to neighboring nodes that have available processing and memory resources. Since the VNFs have various resource requirements, without further consideration, the SFC migration process may create load imbalance at the neighboring nodes. The load imbalance may also be due to residual loads occupying the RF nodes from other requests. To lower the load imbalance, the HF node may assign a dynamic migration load amount to each neighboring node according to their current load. By so doing, the HF node distributes the load balance to the RF nodes in a fair (e.g., equitable) manner. Therefore, in some embodiments, the HF node utilizes a local node proximity diffusion technique, and the load may be migrated towards neighboring RF nodes that have least load, or the most freed processing and/or memory resources. By so doing, the HF node can achieve equal global balancing in each cluster or cell (e.g., cells 302, 304, and 306 of FIG. 3). This load balancing technique may be a decentralized task migration approach, where the respective HF nodes of each cell may act independently and/or asynchronously in the load diffusion process.

In some embodiments, by utilizing the example pseudocode of FIGS. 12A and 12B, the HF node can converge the uneven load status at each RF node in the cluster or cell. The balancing process may be achieved at a migration frequency for k∈K iteration, during which a node (e.g., an RF node) may receive a load status information from its immediate neighbors. Each node receives a load status of the direct neighbor Lᵢ in the cluster or cell. In some embodiments, the load balancing may be determined by initially determining the maximum (upper bound) load that can be migrated to a single RF node, which may be mathematically expressed as Lₘₐₓ(n_{rf})=ß(n_{rf})L_{cap}(n_{rf}), where Lₘₐₓ(n_{rf}) denotes the processing capacity at the RF node, and ß(n_{rf}) denotes the saturation threshold at n_{rf}. The migrated load to each RF node may be mathematically expressed as L_{mig}(n_{rf})=Lₘₐₓ(n_{rf})−L_{curr}(n_{rf}), where L_{curr} denotes the current load occupancy at the RF node. The example pseudocode of FIGS. 12A and 12B details various migration schemes of the data traffic from an HF node to the RF nodes, such as an HRF migration scheme, an LRF migration scheme, an HVF migration scheme, and an LVF migration scheme.

In some embodiments, following the migration process using any of the migration schemes, the average load may be equal among RF nodes (e.g., immediate neighboring nodes, leaf nodes, beta node, etc.) at (t+τ)th time step, L̅_{avg}, which may be mathematically expressed using Equation 21 of FIG. 13C.

In some embodiments, the load migration process may include migrating excess load to deficient neighbors by assigning a load weight hₖ to the leaf nodes, as may be mathematically expressed using Equation 22 of FIG. 13D. These weights may be summed to determine the total deficiency surplus, Hₚ, as may be mathematically expressed using Equation 23 of FIG. 13D. In such a case, the total migrated load that is migrated to each neighbor node, or RF node, L_{mig}(n_{rf}), may meet a criterion, where the criterion may be mathematically expressed using Equation 24 of FIG. 13D. This load balancing criterion may continue during the entire migration process to maintain the load level at every RF node equal to the average local load in the cell (e.g., cells 302, 304, and/or 306 of FIG. 3), which may be achieved through K iterations (load migration steps generated from the HF node), after which the load imbalance may be diffused among all neighboring, leaf, children, and/or RF nodes.

### Examples

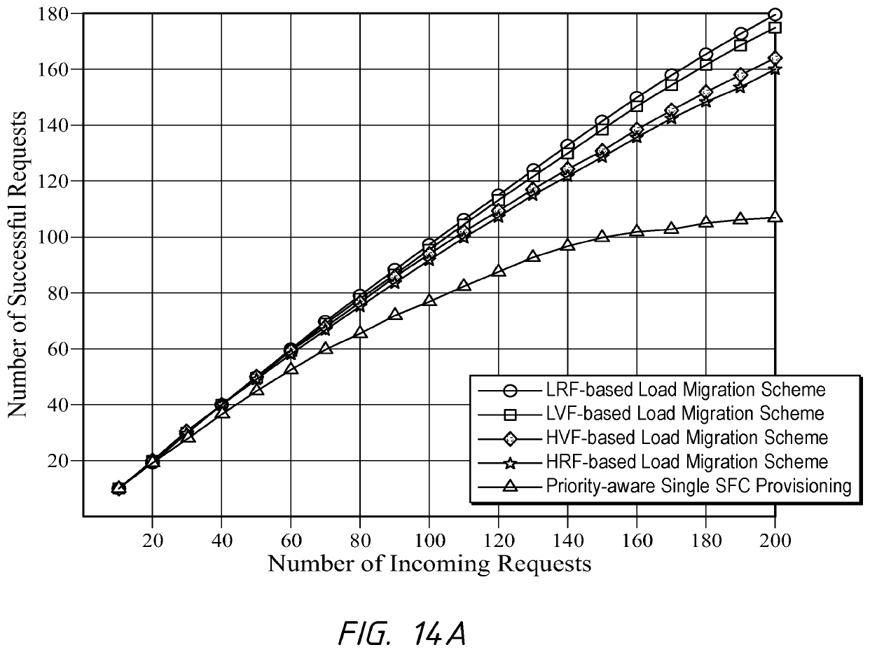

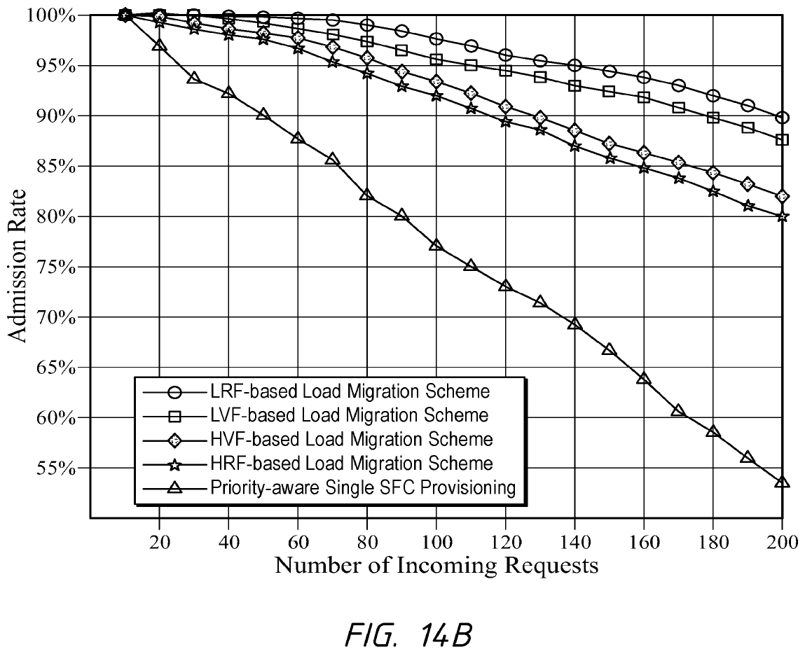

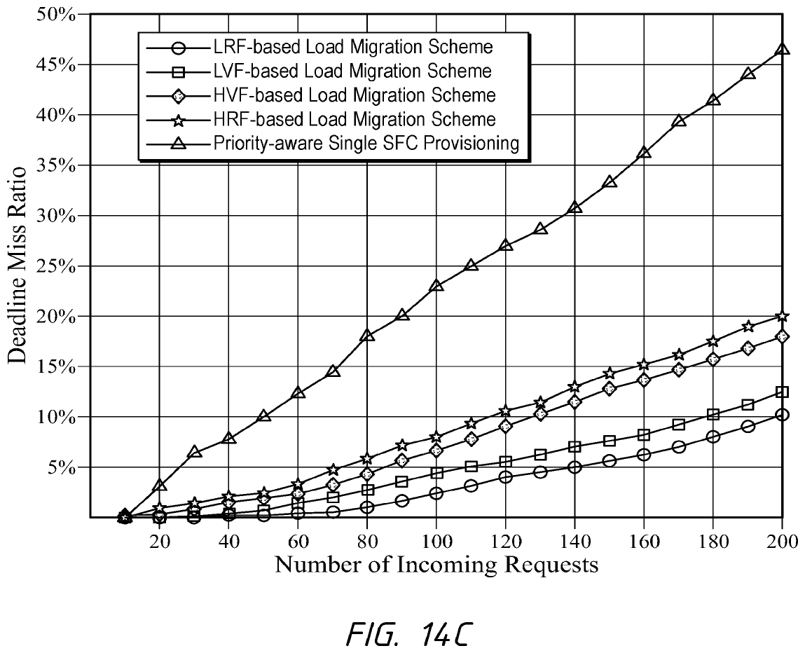

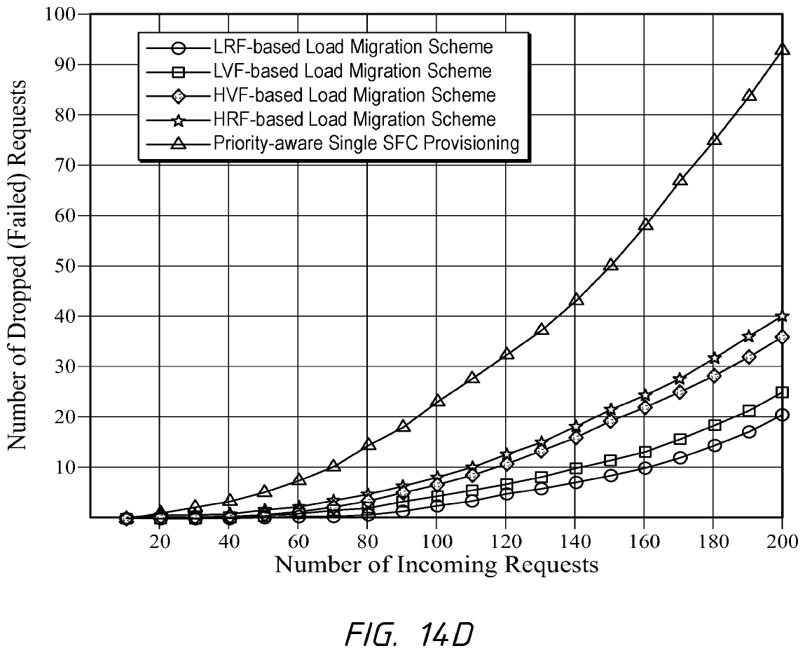

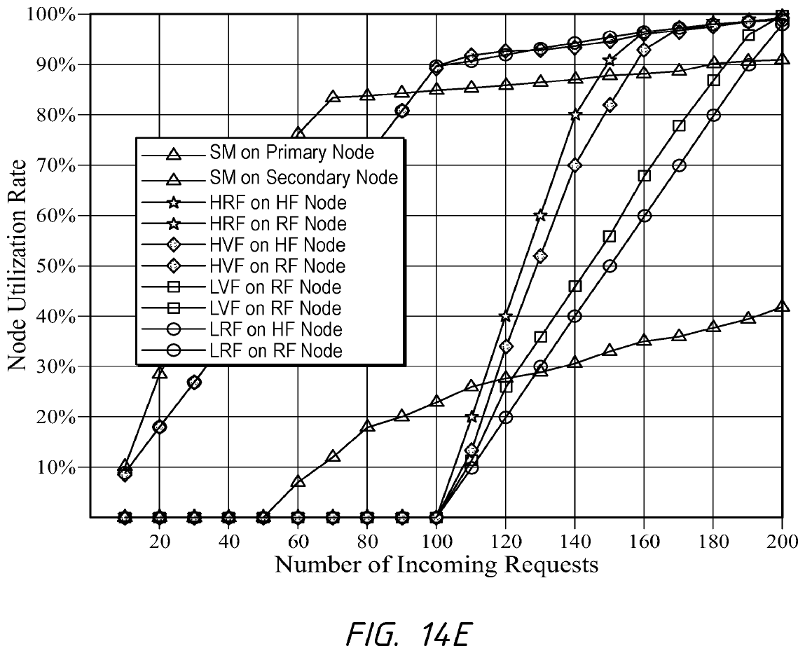

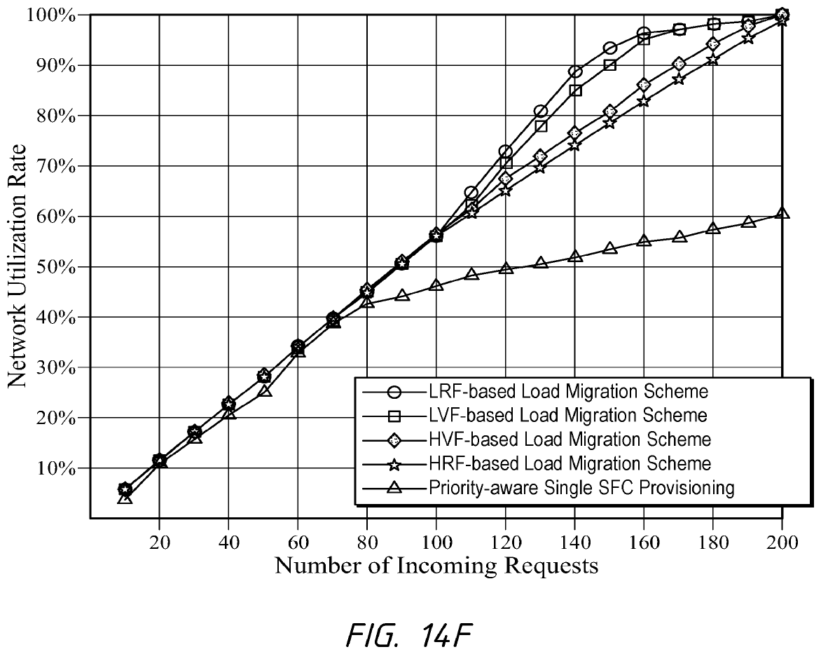

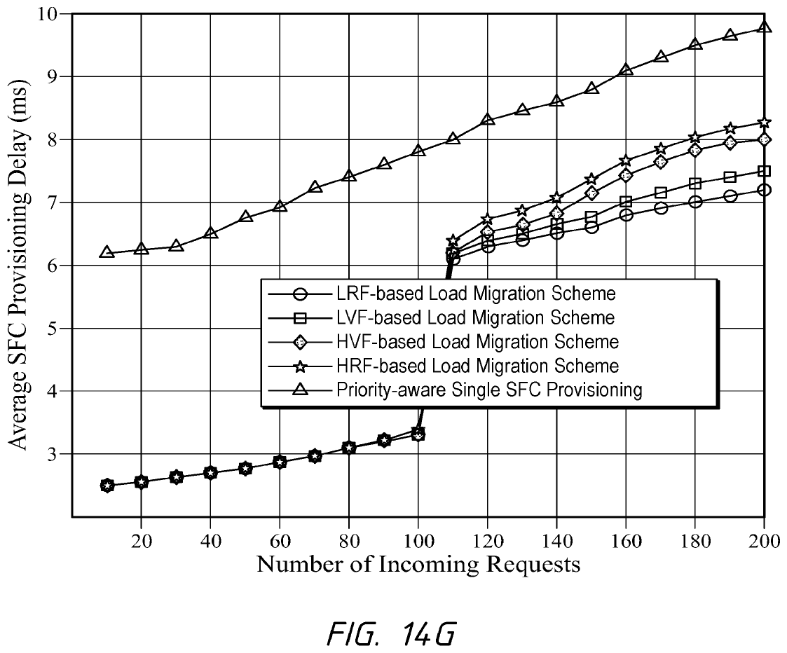

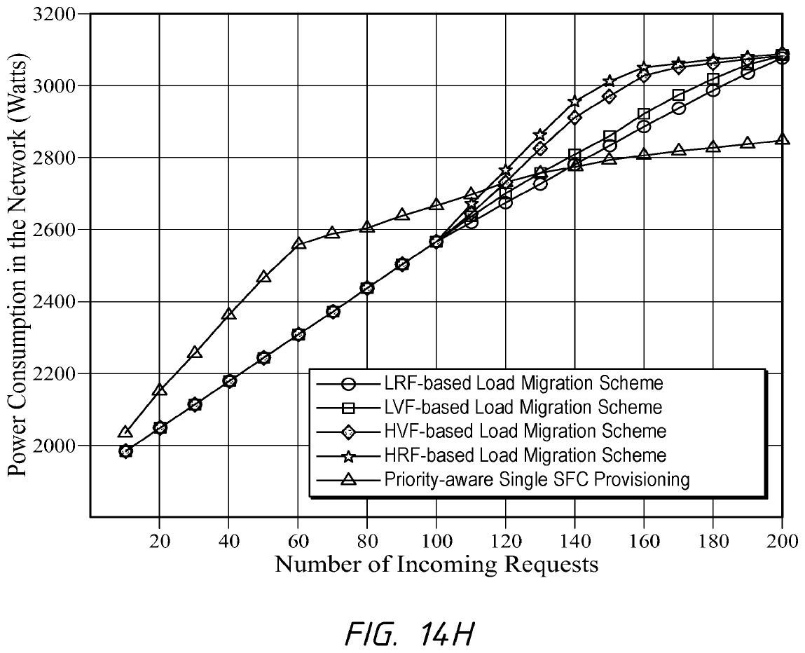

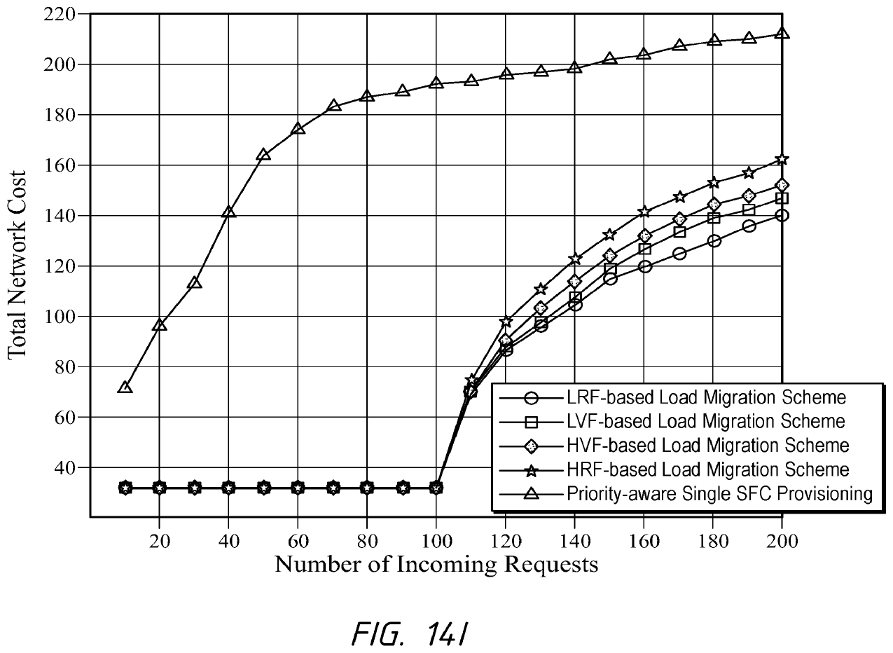

FIGS. 14A to 14I illustrate example results of the performance of systems and methods for mapping, migrating, and/or processing data over a network system. FIGS. 14A to 14I may be described in the context of FIGS. 1 to 13E. For example, the network system associated with the results of FIGS. 14A to 14I and/or Table I may be a portion of, equivalent to, or include the network system 100 of FIG. 1, the network system 200 of FIG. 2, the heterogeneous fog architecture 300 of FIG. 3, the quadratic tree 400 of FIG. 4, etc.

In some embodiments, the network simulations may be conducted for an SFC provisioning scheme over the heterogeneous fog architecture. The results of these simulations may be compared against priority-aware (time-delay) single SFC mapping. Requests may be initiated from, for example, 200 terminal devices (e.g., terminal devices 130 to 142 of FIG. 1, terminal device 212 of FIG. 2) and/or their applications (e.g., application(s) 214 of FIG. 2). These requests may be received at five clusters or cells, where each cluster or cell may include, for example, one HF node, four RF nodes, and 40 terminal devices.

In some embodiments, the generated requests from the terminal devices may exhibit various time-delay and processing requirements. These simulations may consider the worst-case scenario, where the requests are delay-sensitive and computational-intensive requests. It is to be appreciated that other network solutions struggle to properly process and/or store delay-sensitive and computational-intensive requests. The heterogeneous fog architecture described herein can support mission-critical and real-time applications that use high data traffic rates. The simulations feature requests with different counts of VNFs in the SFC, varying lifetime periods (e.g., with varying time-delay thresholds, time-delay characteristics), varying processing or computation requirements and/or characteristics, and/or different types of load (e.g., types of VNFs), as is shown in Table I.

TABLE I
Network Parameters

| Parameter | Variable | Value |
|---|---|---|
| Nr. of nodes in network | N | 25 |
| Nr. of HF nodes in network | N_{hf} | 5 |
| Nr. of RF nodes in network | N_{rf} | 20 |
| Nr. of clusters | C | 5 |
| Nr. of all nodes in cluster | N_{c} | 5 |
| Nr. of all links in cluster | E_{c} | 4 |
| Nr. of HF nodes in cluster | η_{hf}^{c} | 1 |
| Nr. of RF nodes in cluster | η_{rf}^{c} | 4 |
| Tree height at root | h(n_{hf}) | 1 |
| Tree height at leaves | h(n_{rf}) | 0 |
| Tree depth at root | d(n_{hf}) | 0 |
| Tree depth at leaves | d(n_{rf}) | 1 |
| Nr. of links | E | 28 |
| Nr. of terminals | Nₜᵣ | 200 |
| Request arrival rate (r/t) | λ | 50 |
| Node processing rate (r/t) | μ(n_{hf}), μ(n_{rf}) | 6, 2 |
| Node processing capacity | Qₚᵣ(n_{hf}), Qₚᵣ(n_{rf}) | 30, 200 |
| Node storage (memory) | Qₘₑ(n_{hf}), Qₘₑ(n_{rf}) | 32, 128 |
| Node unit cost | n_{hf}, n_{rf} | 5, 1 |
| Link unit cost | e_{hf-rf}, e_{hf-hf}, e_{rf-rf} | 5, 5, 1 |
| Required resources | αᵣ(vₛ) = {Qₚᵣ(vₛ), | {Rand[1-3], |
| | Qₘₑ(vₛ)} | Rand[1-4]} |
| Request bandwidth (Mbps) | bᵣ | Rand [1, 10] |
| Nr. of VNFs in a request | \|Vᵣ\| | Rand [4, 6] |
| Link delay (ms) | e_{tr-hf}, e_{hf-rf}, e_{tr-rf}, | 1, 0.8, 0.5, 0.5, 1 |
| | e_{rf-hf}, e_{hf-hf} | |
| VNF processing delay (ms) | Qₚᵣ(n_{hf}), Qₚᵣ(n_{rf}) | 0.5, 1 |
| Service types | S | Rand [3, 6] |
| Delay threshold | δᵣ | 10 ms |
| Node saturation threshold | σ(n_{hf}), σ(n_{rf}) | 90%, 90% |
| Power consumption (W) | β(n), z(x), z(n_{rf}), | 0.7, 15, 65, 130 |
| | z(n_{hf}) | |

FIG. 14A shows a graph of the number (or count) of successful requests vs. the number (or count) of incoming requests. In FIG. 14A, an incoming request is considered successful only if all the VNFs in the SFC are mapped over an HF node, without violating the time-delay bound. To do so, the HF node needs adequate resources to support the request during the entire lifetime, while still processing aggregated data traffic volumes to the network.

In some embodiments, the number of successful (e.g., admitted) requests R_{admit} may depend on the time-delay bound, required resources, resources hold time (lifetime), and subscription cost. Note that the network infrastructure has an impact on the success rates, the number of nodes, links between the nodes, and the computational and/or memory resources. The simulations consider realistic settings, where the available resources are less than the total required resources.

FIG. 14A plots the number of successful requests for the proposed SFC provisioning scheme. As is shown in FIG. 14A, in some embodiments, the LRF migration scheme may yield the highest admission levels, followed by the LVF, the HVF, and the HRF migration schemes. FIG. 14B shows the corresponding admission rates. These admission rates are considerably higher compared to a single SFC provisioning scheme, where the single SFC provisioning scheme is not utilized by the heterogeneous fog architecture described herein. The single SFC provisioning scheme differs from the described SFC provisioning schemes because the single SFC provisioning scheme places the plurality of VNFs across a plurality of fog nodes (e.g., physical fog nodes), without grouping the VNFs.

In some embodiments, the request path for the proposed VNF grouping approach includes a single HF node and a few hopping nodes to reach the destination node. Moreover, the high processing capacity at the HF node allows for high VNF accommodation at reduced network delays, without introducing hopping delays.

Generally, the proposed SFC provisioning schemes achieve noticeable performance improvement over the single SFC provisioning scheme. Note that the request path in the single SFC provisioning scheme (e.g., prior art) may include multiple primary nodes and few secondary nodes to achieve load balancing. Therefore, it should be appreciated that the heterogeneous fog architecture and the SFC provisioning scheme described herein yield better results regardless of the chosen migration scheme (e.g., an HRF, an LRF, an HVF, or an LVF migration scheme).

In some embodiments, the QoS criterion may be gauged by the deadline miss ratio (DMR) for incoming requests. The DMR may define the number (or count) of request violations whose delay bound has been exceeded during the SFC provisioning. The DMR may be mathematically expressed using Equation 25 of FIG. 13D. In Equation 25, Rₘᵢₛ denotes the number of missed (or failed) requests due to exceeding the delay bound, and R_{admit} denotes the number of admitted requests. The proposed SFC provisioning scheme presents tolerable deadline misses as the traffic load increases.

The QoS for the proposed SFC provisioning scheme may be modeled using a three-tuple, Q={λ, δᵣ, γ}, where λ denotes the arrival rate at the (t)th time step, δᵣ denotes the delay bound (deadline) for the delay-sensitive requests, and γ denotes the admission rate. The deadline miss probability Pₘᵢₛ for request r, following λ arrival rate and node μ(n) processing rate may be mathematically expressed using Equation 26 of FIG. 13D.

In some embodiments, the SFC provisioning scheme may set the node (e.g., host node) processing rate of incoming requests equal to, or higher than, the arrival rate at the node. This may be useful when the utilization rate of the node is below the threshold level. By so doing, the SFC provisioning scheme described herein can reduce the miss ratio and increase the QoS, which may be mathematically expressed using Equation 27 of FIG. 13D. In Equation 27, the term (1−R_{admit}) represents the QoS violations (e.g., percentage of QoS violations). This setting can help the network to provide better service and reduce the miss ratio.

FIGS. 14C and 14D show that the proposed set of migration schemes feature low miss (or blockage) rates at different traffic volumes. FIG. 14C shows the DMR vs. number (or count) of incoming requests. FIG. 14D shows the number (or count) of dropped (or failed) requests vs. the number (or count) of incoming requests.

The simulation results also show node and network utilization rates. A performance indicator may be the network utilization rate U measured by the aggregated sum of the occupied resources in the host nodes u(n) and interconnected links u(e) from the total available resources, which may be mathematically expressed using Equation 28 of FIG. 13D. In Equation 28, \hat{Q}ₚᵣ(n) denotes the processing resources at the host node, \hat{Q}ₘₑ(n) denotes the memory resources at the host node, and \hat{B}(e) denotes the utilized link bandwidth.

FIG. 14E shows simulation results of the nodes' utilization rate (in percent) vs. the number (or count) of the incoming requests. FIG. 14F shows simulation results of the network's utilization rate (in percent) vs. the number (or count) of the incoming requests.

In some embodiments, the SFC provisioning delay may be defined as the time required to embed all the VNFs in the SFC request r on a node, for example, prior to the start of the service. This delay may incorporate the node processing time D_{proc}(r) and the link propagation time Dₚᵣₒₚ(r), which may be mathematically expressed as Dᵣ=D_{proc}(r)+Dₚᵣₒₚ(r). In some embodiments, the node processing time for any VNF may depend on the data traffic load per request r, lᵣ; the VNF processing time Qₚᵣ(vₛ) and the computation requirements D(Qₚᵣ(vₛ)). The node processing time may be mathematically expressed using Equation 29 of FIG. 13E.

In some embodiments, the link propagation time Dₚᵣₒₚ(e) for a request r may include the propagation period across all links interconnecting host nodes between the src and dest, over which the VNFs are mapped. This also may correspond to the path delay of the SFC for request r. The value of the link propagation time may be gauged over a medium propagation speed ζ(e) for all the links in the established request path Pathᵣ. The link propagation time Dₚᵣₒₚ(r) may be expressed using Equation 30 of FIG. 13E.

FIG. 14G shows simulation results of the average SFC provisioning delay (in milliseconds (ms)) vs. the number (or count) of the incoming requests. As shown in FIG. 14G, regardless of the number of requests, the proposed SFC provisioning scheme performs considerably better (shorter delay) than a single SFC provisioning scheme.

In some embodiments, power consumption may be a factor for network operators (e.g., an owner and/or operator of the described heterogeneous fog architecture) in meeting the increased traffic demands of terminal devices. A power consumption model at a host fog node z(n), n∈N−{Nₜᵣ} may be mathematically expressed using Equation 31 of FIG. 13E. In Equation 31, the variable β(n) denotes the node power consumption in idle state, z(n)|ₘₐₓ is the maximum node power consumption, and σ(n) is the node saturation rate (or a utilization factor). In some embodiments, the total power consumption for the entire set of hosting nodes for request r may be expressed using Equation 32 of FIG. 13E.

In some embodiments, the total power consumption in the network attributed to the number of nodes and switches at various utilization rates may be gauged using the HF nodes, RF nodes, a cell of the heterogeneous fog architecture, the entire heterogeneous fog architecture, or combinations thereof, as may be expressed using Equation 33 of FIG. 13E. In Equation 33, the variable z(x) denotes the power consumption for one switch, x (for X number of switches).

In some embodiments, FIG. 14H shows simulation results of the power consumption in the network (in Watts) vs. the number (or count) of incoming requests.

In some embodiments, the total cost for all nodes and links in the request path, Pathᵣ, may be mathematically expressed using Equation 34 of FIG. 13E. In Equation 34, Γ(n) denotes the node and unit usage costs for the VNFs' resources demands ar. Similarly, Γ(e) denotes the link unit usage costs for the VNFs' resources bandwidth demands bᵣ.

FIG. 14I shows simulation results of the total network cost vs. the number (or count) of incoming requests. It should be appreciated that any of the proposed SFC provisioning schemes includes a lower cost compared to the single SFC provisioning scheme.

From the foregoing it will be appreciated that, although specific embodiments have been described herein for purposes of illustration, various modifications may be made while remaining within the scope of the claimed technology.

Examples of requests of a terminal device or an application of a terminal device may include online gaming, autonomous and/or assisted driving, medical diagnostic requests, image processing requests, social media requests, voice over Internet protocol (VoIP) requests, short message service (SMS) requests, financial transaction requests, or other requests that may be delay-sensitive requests, computation-intensive requests, or combinations thereof.

Examples described herein may refer to various components as “coupled” or signals as being “provided to” or “received from” certain components or nodes. It is to be understood that in some examples the components are directly coupled one to another, while in other examples, the components are coupled with intervening components disposed between them. Similarly, signals or communications may be provided directly to and/or received directly from the recited components without intervening components, but also may be provided to and/or received from the certain components through intervening components.

What is claimed is:

1. A data network comprising an alpha node, a first beta node, and a second beta node, wherein each of the first and the second beta nodes are communicatively coupled to the alpha node, and wherein the alpha node is configurable to:
receive data traffic belonging to one or more requests from one or more user devices;
check whether a threshold of data traffic is met;
upon meeting the threshold, generate a queue to the first beta node, the second beta node, or a combination thereof;
assign one or more factors from a plurality of factors to at least a portion of the data traffic, wherein each of the plurality of factors comprises a type of the data traffic, a total amount of the portion of the data traffic, a first amount of the portion of the data traffic accepted by the first beta node, a second amount of the portion of the data traffic accepted by the second beta node, or combinations thereof; and
based, in part, on the one or more factors, selectively migrate the first and the second amounts of the portion of the data traffic to the first and the second beta nodes, respectively, by using a migration scheme of a plurality of migration schemes.

2. The data network of claim 1, wherein the first and the second beta nodes are further communicatively coupled to each other.

3. The data network of claim 1, wherein the alpha node, the first beta node, and the second beta node are neighboring nodes.

4. The data network of claim 1, wherein the migration scheme comprises a highest resources first (HRF) migration scheme.

5. The data network of claim 1, wherein the migration scheme comprises a lowest resources first (LRF) migration scheme.

6. The data network of claim 1, wherein the migration scheme comprises a highest virtual network functions (VNFs) first migration scheme.

7. The method of claim 1, wherein the migration scheme comprises a lowest count of VNFs first migration scheme.

8. The data network of claim 1, wherein the alpha node comprises a baseband unit (BBU) collocated with an alpha radio remote head (RRH).

9. The data network of claim 8, wherein one of the first and the second beta nodes comprises a server collocated with a beta RRH.

10. The data network of claim 9, wherein the alpha RRH comprises a first power RRH, the beta RRH comprises a second power RRH, and wherein the first power RRH comprises a higher power than the second power RRH.

11. The data network of claim 1, wherein the alpha node comprises a first computational and memory capacity, each of the first and the second beta nodes comprises a second computational and memory capacity, and wherein the first computational and memory capacity comprises a higher capacity than the second computational and memory capacity.

12. The data network of claim 1, wherein the type of the data traffic comprises a time-delay threshold for processing the one or more data requests.

13. The data network of claim 1, wherein the total amount of the one or more portions of the data traffic comprises a computation-intensive characteristic, and wherein the computation-intensive characteristic comprises one or more of a measures of a processing speed, a processing power, an amount of memory, a data traffic intensity, or combinations thereof.

14. The data network of claim 1 further comprises a heterogeneous fog architecture with one or more tree structures, wherein the alpha node comprises a root node of each of the one or more tree structures, the first beta node comprises a first leaf node of each of the one or more tree structures, and the second beta node comprises a second leaf node of each of the one or more tree structures.

15. A method of performing computations over a network, the method comprises:
determining, using a hyper fog node, a time-delay requirement and a computation requirement of an application of a terminal device;
grouping, using the hyper fog node, a plurality of virtual network functions (VNFs) in a service function chain (SFC) associated with the application:
monitoring a data traffic threshold associated with the plurality of VNFs; and
upon meeting the data traffic threshold, migrating the plurality of VNFs from the hyper fog node to one or more regular fog nodes.

16. The method of claim 15 further comprises maintaining the hyper fog node in an active operation mode.

17. The method of claim 15 further comprises maintaining the one or more regular fog nodes in an idle operation mode prior to the migrating, wherein the idle operation mode decreases an amount of energy used by the one or more regular fog nodes.

18. The method of claim 15 further comprises:
determining a type of each VNF of the plurality of VNFs; and
based on the type of each VNF of the plurality of VNFs, selecting a migration scheme of a plurality of migration schemes.

19. The method of claim 15, wherein the migrating uses a highest resources first (HRF) migration scheme.

20. The method of claim 15, wherein the migrating uses a lowest resources first (LRF) migration scheme.

21. The method of claim 15, wherein the migrating uses a highest VNFs first migration scheme.

22. The method of claim 15, wherein the migrating uses a lowest VNFs first migration scheme.
